(19) United States
(12) Patent Application Publication
(10) Pub. No.: US 2026/0357007 A1
(43) Pub. Date: Nov. 12, 2026

(54) PHOTOREVERSIBLE POLYMERS AND METHODS OF USE THEREOF

(71) Applicants: ARIZONA BOARD OF REGENTS ON BEHALF OF ARIZONA STATE UNIVERSITY, Scottsdale, AZ (US); INTEL CORPORATION, Santa Clara, CA (US)

(72) Inventors: Charlotte Barker, Tempe, AZ (US); Jose Sintas, Phoenix, AZ (US); Timothy Long, Phoenix, AZ (US); Clay Arrington, Queen Creek, AZ (US); Dingying Xu, Chandler, AZ (US); Kyle Arrington, Gilbert, AZ (US); Boer Liu, Chandler, AZ (US)

(21) Appl. No.: 19/656,905

(22) Filed: Apr. 23, 2026

Related U.S. Application Data
(60) Provisional application No. 63/793,524, filed on Apr. 23, 2025.

(51) Int. Cl. C08G 65/48; C08G 71/04; C09J 171/08

(52) U.S. Cl. CPC C08G 65/48; C08G 71/04; C09J 171/08; C08G 2170/00; C08G 2650/20

(57) ABSTRACT

The present invention relates to photoreversible polymers for water dispersity and methods of use thereof. In embodiments, a functionalized derivative of a photocleavable coumarin dimer or a residue thereof can be polymerized with at least one comonomer to create a polymer or polymer composition. The polymer or polymer composition can be an adhesive. Aspects of the disclosure are drawn towards a method of using said adhesive in the processing semiconductor wafers in chip manufacture.

This application claims priority to U.S. Provisional Application No. 63/793,524 filed on Apr. 23, 2025, the entire contents of which are incorporated herein by reference.

All patents, patent applications and publications cited herein are hereby incorporated by reference in their entirety. The disclosures of these publications in their entireties are hereby incorporated by reference into this application in order to more fully describe the state of the art as known to those skilled therein as of the date of the invention described and claimed herein.

This patent disclosure contains material that is subject to copyright protection. The copyright owner has no objection to the facsimile reproduction by anyone of the patent document or the patent disclosure as it appears in the U.S. Patent and Trademark Office patent file or records but otherwise reserves any and all copyright rights.

### FIELD OF THE INVENTION

The present invention relates to photoreversible polymers and methods of use thereof.

### BACKGROUND OF THE INVENTION

As the semiconductor industry continues to make new advances in material developments, the synthesis of photoreversible polymers for bond-debond applications is of particular interest. These materials serve to have strong adhesive properties in the semiconductor manufacturing process, but adhesive strength can effectively be turned off using light at specific reversal wavelengths for debonding steps. Additionally, water dispersibility after photocleavage of the polymer chains is of particular interest in the semiconductor field.

### SUMMARY OF THE INVENTION

Aspects of the invention are drawn towards a polymer or polymer composition comprising a repeat unit residue of the monomer of Formula (I),

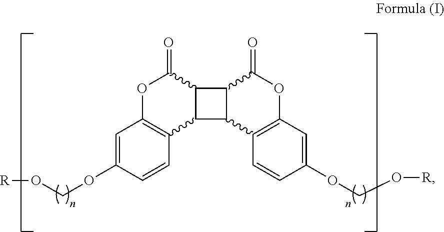

and
at least one comonomer residue, wherein n=1-20 and R=H, a vinyl residue, an acrylate residue, a diacid residue, a diester residue, a diisocyanate residue, a diamine residue, a diamide residue, or a dithiol residue. In embodiments, the vinyl residue is selected from: an N-vinylpyrrolidone residue, an acrylamide residue, an acrylic acid residue, or

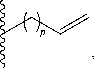

wherein p=0-10; the epoxy residue is:

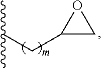

wherein m=1-4; the acrylate residue is selected from the group consisting of: a glycol acrylate residue, a hydroxyethyl acrylate residue, or

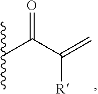

wherein R′=H or C₁-C₃ alkyl. In embodiments, diacid residue is:

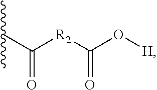

wherein R₂=C₁-C₁₆ alkylene, C₁-C₂₀ alkenyl, C₆-C₈ arylene, naphthylene, oxo, or thioalkylene. In embodiments, the diester residue is:

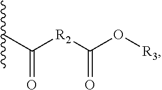

wherein R₂=C₁-C₁₆ alkylene, C₁-C₂₀ alkenyl, C₆-C₈ arylene, naphthylene, oxo, or thioalkylene, and R₃=H or C₁-C₆ alkyl. In embodiments, the diisocyanate residue is:

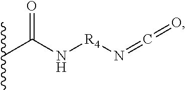

wherein R₄=alkylene, branched alkylene, cycloalkylene, branched cycloalkylene, hetero-cycloalkylene, arylene, naphthylene, alkenyl, oxo, or thioalkylene. In embodiments, the dithiol residue is:

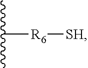

wherein R₆=C₂-C₁₂ alkylene or a substituted C₂-C₁₂ alkylene, wherein the substituents are selected from an ether (—O—) or a carbonyl (—C(═O)—). In embodiments, the diamine residue is

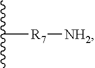

wherein R₇=C₂-C₁₂ alkylene, C₂-C₁₂ branched alkylene, C₆-C₁₄ arylene, biphenylene, hetero-arylene, C₁-C₁₂ hetero-alkylene, or substituted derivatives thereof, wherein the substituents are independently selected from C₁-C₆ alkyl, C₁-C₆alkoxy, halo, ether (—O—), carbonyl (—C(═O)—), sulfone (—SO₂—), or combinations thereof. In embodiments, the diamide residue is:

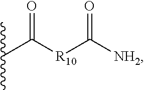

wherein R₁₀=C₂-C₁₂ alkylene, C₂-C₁₂ branched alkylene, C₆-C₁₄ arylene, naphthylene, hetero arylene, C₁-C₁₂ hetero-alkylene, or substituted derivatives thereof, wherein the substituents are independently selected from C₁-C₆ alkyl, C₁-C₆ alkoxy, halo, ether (—O—), carbonyl (—C(═O)—), sulfone (—SO₂—), or combinations thereof.

In embodiments of the polymer or polymer composition described herein, R=H and the at least one co-monomer residue is selected from the group consisting of: a diacid monomer residue of:

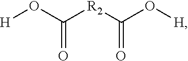

wherein R₂=C₁-C₁₆ alkylene, C₁-C₂₀ alkenylene, C₆-C₈ arylene, naphthylene, —O—, —C(═O)—, or thioalkylene; a diester monomer residue of:

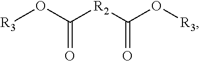

wherein R₂=C₁-C₁₆ alkylene, C₁-C₂₀ alkenylene, C₆-C₈ arylene, naphthylene, —O—, —C(═O)—, or thioalkylene, and R₃=H, C₁-C₆ alkyl, or phenyl; a diisocyanate monomer residue of:

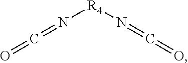

wherein R₄=alkylene, branched alkylene, cycloalkylene, branched cycloalkylene, hetero-cycloalkylene, arylene, naphthylene, alkenylene, —O—, —C(═O)—, or thioalkylene; or a combination thereof.

In embodiments of the polymer or polymer composition described herein, R=an epoxy residue and the at least one co-monomer residue is selected from the group consisting of: a diisocyanate monomer residue of:

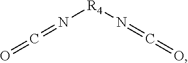

wherein R₄=alkylene, branched alkylene, cycloalkylene, branched cycloalkylene, hetero-cycloalkylene, arylene, naphthylene, alkenylene, —O—, —C(═O)—, or thioalkylene; a diamine monomer residue of:

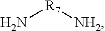

wherein R₇=C₂-C₁₂ alkylene, C₂-C₁₂ branched alkylene, C₆-C₁₄ arylene, naphthylene, hetero arylene, C₁-C₁₂ hetero-alkylene, or substituted derivatives thereof, wherein the substituents are independently selected from C₁-C₆ alkyl, C₁-C₆ alkoxy, halo, ether (—O—), carbonyl (—C(═O)—), sulfone (—SO₂—), or combinations thereof; a dithiol monomer residue of:

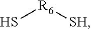

wherein R₆=C₂-C₁₂ alkylene or a substituted C₂-C₁₂ alkylene, wherein the substituents are selected from an ether (—O—) or a carbonyl (—C(═O)—); a diol monomer residue of:

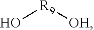

wherein R₉=C₂-C₁₂ alkylene, branched C₃-C₁₂ alkylene, poly(alkylene)oxy alkylene, cycloalkylene, non-phenolic arylene, or ester containing alkylene; or a combination thereof.

In embodiments of the polymer or polymer composition described herein, R=a vinyl residue or an acrylate residue and the at least one co-monomer residue is selected from the group consisting of:

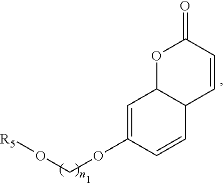

wherein n₁=1-20, and R₅=an acrylate residue, or a vinyl residue; an acrylate monomer residue; a vinyl monomer residue; a dithiol monomer residue of:

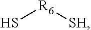

wherein R₆=C₂-C₁₂ alkylene or substituted C₂-C₁₂ alkylene, wherein the substituents are selected from an ether (—O—) or a carbonyl (—C(═O)—); a diamine residue of:

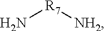

wherein R₇=C₂-C₁₂ alkylene, C₂-C₁₂ branched alkylene, C₆-C₁₄ arylene, naphthylene, hetero arylene, C₁-C₁₂ hetero-alkylene, or substituted derivatives thereof, wherein the substituents are independently selected from C₁-C₆ alkyl, C₁-C₆ alkoxy, halo, ether (—O—), carbonyl (—C(═O)—), sulfone (—SO₂—), or combinations thereof; or a combination thereof.

In embodiments of the polymer or polymer composition described herein, R=a diacid residue and the at least one co-monomer residue is selected from the group consisting of: a diacid monomer residue of:

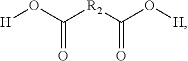

wherein R₂=C₁-C₁₆ alkylene, C₁-C₂₀ alkenyl, C₆-C₈ arylene, naphthylene, —O—, —C(═O)—, or thioalkylene; a diisocyanate residue of:

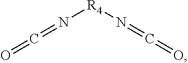

wherein R₄=alkylene, branched alkylene, cycloalkylene, branched cycloalkylene, hetero-cycloalkylene, arylene, naphthylene, alkenylene, —O—, —C(═O)—, or thioalkylene; a diol monomer residue of:

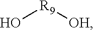

wherein R₉=C₂-C₁₂ alkylene, branched C₃-C₁₂ alkylene, poly(alkylene)oxy alkylene, cycloalkylene, non-phenolic arylalkylene, an ester containing alkylene, or a carbonyl-containing alkylene; a diamine monomer residue of:

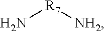

wherein R₇=C₂-C₁₂ alkylene, C₂-C₁₂ branched alkylene, C₆-C₁₄ arylene, naphthylene, hetero arylene, C₁-C₁₂ hetero-alkylene, or substituted derivatives thereof, wherein the substituents are independently selected from C₁-C₆ alkyl, C₁-C₆ alkoxy, halo, ether (—O—), carbonyl (—C(═O)—), sulfone (—SO₂—), or combinations thereof; a dithiol monomer residue of

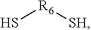

wherein R₆=C₂-C₁₂ alkylene or substituted C₂-C₁₂ alkylene, wherein the substituents are selected from an ether (—O—) or a carbonyl (—C(═O)—); or a combination thereof.

In embodiments of the polymer or polymer composition described herein, R=a diester residue and the at least one co-monomer residue is selected from the group consisting of: a diester monomer residue of:

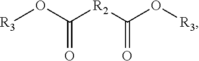

wherein R₂=C₁-C₁₆ alkylene, C₁-C₂₀ alkenyl, C₆-C₈ arylene, naphthylene, —O—, —C(═O)—, or thioalkylene, and R₃=H, C₁-C₆ alkyl, or phenyl; a diol monomer residue of:

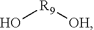

wherein R₉=C₂-C₁₂ alkylene, branched C₃-C₁₂ alkylene, poly(alkylene)oxy alkylene, cycloalkylene, non-phenolic arylalkylene, ester containing alkylene, or a carbonyl-containing alkylene; a diamine monomer residue of:

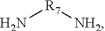

wherein R₇=C₂-C₁₂ alkylene, C₂-C₁₂ branched alkylene, C₆-C₁₄ arylene, naphthylene, hetero arylene, C₁-C₁₂ hetero-alkylene, or substituted derivatives thereof, wherein the substituents are selected from C₁-C₆ alkyl, C₁-C₆ alkoxy, halo, ether (—O—), carbonyl (—C(═O)—), sulfone (—SO₂—), or combinations thereof; a dithiol monomer residue of:

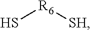

wherein R₆=C₂-C₁₂ alkylene or substituted C₂-C₁₂ alkylene, wherein the substituents are selected from an ether (—O—) or a carbonyl (—C(═O)—); or a combination thereof.

In embodiments of the polymer or polymer composition described herein, R=a diisocyanate residue and the at least one co-monomer residue is selected from the group consisting of: a diacid monomer residue of:

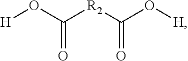

wherein R₂=C₁-C₁₆ alkylene, C₁-C₂₀ alkenyl, C₆-C₈ arylene, naphthylene, —O—, —C(═O)—, or thioalkylene; a diol monomer residue of:

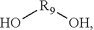

wherein R₉=C₂-C₁₂ alkylene, branched C₃-C₁₂ alkylene, poly(alkylene)oxy alkylene, cycloalkylene, non-phenolic arylalkylene, an ester containing alkylene, or a carbonyl-containing alkylene; a diamine monomer residue of:

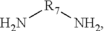

wherein R₇=C₂-C₁₂ alkyl, C₂-C₁₂ branched alkyl, C₆-C₁₄ aryl, biphenyl, heteroaryl, C₁-C₁₂ hetero-alkyl, or substituted derivatives thereof, wherein the substituents selected from C₁-C₆ alkyl, C₁-C₆ alkoxy, halo, ether (—O—), carbonyl (—C(═O)—), sulfone (—SO₂—), or combinations thereof; a dithiol monomer residue of

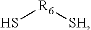

wherein R₆=C₂-C₁₂ alkylene, C₂-C₁₂ branched alkylene, C₆-C₁₄ arylene, naphthylene, hetero arylene, C₁-C₁₂ hetero alkylene; or a combination thereof.

In embodiments of the polymer or polymer composition described herein, R=a diamine residue, the at least one co-monomer residue is selected from the group consisting of: an acrylate monomer residue; a diisocyanate residue of:

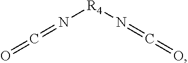

wherein R₄=alkylene, branched alkylene, cycloalkylene, branched cycloalkylene, hetero-cycloalkylene, arylene, naphthylene, alkenylene, —O—, —C(═O)—, or thioalkylene; a diacid monomer residue of:

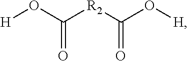

wherein R₂=C₁-C₁₆ alkylene, C₁-C₂₀ alkenyl, C₆-C₈ arylene, naphthylene, —O—, —C(═O)—, or thioalkylene; a diester monomer residue of:

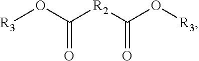

wherein R₂=C₁-C₁₆ alkylene, C₁-C₂₀ alkenyl, C₆-C₈ arylene, naphthylene, —O—, —C(═O)—, or thioalkylene, and R₃=H, C₁-C₆ alkyl, or phenyl; a combination thereof.

In embodiments of the polymer or polymer composition described herein, R=a dithiol residue, the at least one co-monomer residue is selected from the group consisting of: an acrylate monomer residue, a vinyl monomer residue; a diacid monomer residue of:

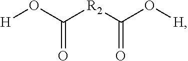

wherein R₂=C₁-C₁₆ alkylene, C₁-C₂₀ alkenyl, C₆-C₈ arylene, naphthylene, —O—, —C(═O)—, or thioalkylene; a diester monomer residue of:

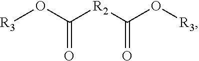

wherein R₂=C₁-C₁₆ alkylene, C₁-C₂₀ alkenyl, C₆-C₈ arylene, naphthylene, —O—, —C(═O)—, or thioalkylene, and R₃=H, C₁-C₆ alkyl, or phenyl; or a combination thereof

In embodiments of the polymer or polymer composition described herein, R=a diamide residue, the at least one co-monomer residue is selected from the group consisting of: a diamine monomer residue of:

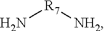

wherein R₇=C₂-C₁₂ alkyl, C₂-C₁₂ branched alkyl, C₆-C₁₄ aryl, biphenyl, heteroaryl, C₁-C₁₂ hetero-alkyl, or substituted derivatives thereof, wherein the substituents are independently selected from C₁-C₆ alkyl, C₁-C₆ alkoxy, halo, ether (—O—), carbonyl (—C(═O)—), sulfone (—SO₂—), or combinations thereof; a diol monomer residue of:

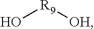

wherein R₉=C₂-C₁₂ alkylene, branched C₃-C₁₂ alkylene, poly(alkylene)oxy alkylene, cycloalkylene, arylalkylene, or ester containing alkylene; a diisocyanate residue of:

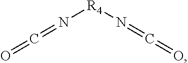

wherein R₄=alkylene, branched alkylene, cycloalkylene, branched cycloalkylene, hetero-cycloalkylene, arylene, naphthylene, alkenylene, —O—, —C(═O)—, or thioalkylene; or a combination thereof.

In embodiments of the polymer or polymer composition described herein, the residue of Formula (I) is present in about 5 mol. % to about 75 mol. % of the at least one co-monomer. In embodiments, the polymer or polymer composition comprises an Mₙ of about 10,000 g/mol to about 40,000 g/mol. In embodiments of the polymer or polymer composition described herein, the polymer or polymer composition undergoes photocleavage below about 300 nm. In embodiments of the polymer or polymer composition described herein, the polymer or polymer composition undergoes photodimerization at about 315 nm to about 350 nm. In embodiments of the polymer or polymer composition described herein, the polymer or polymer composition is water soluble or water dispersible after photocleavage. In embodiments of the polymer or polymer composition described herein, the polymer or polymer composition is a polyester, a polyurethane, a co-polymer thereof, or a cross-linked polymer or polymer composition thereof. In embodiments, the polymer or polymer composition is a bond-debond adhesive.

Aspects of the disclosure are drawn towards a photocleavable adhesive composition comprising a polymer or polymer composition described herein.

Aspects of the disclosure are drawn towards a method of temporarily bonding a support substrate to a semiconductor wafer for processing, the method comprising: obtaining a device wafer and a support substrate; applying the photocleavable polymer or photocleavable polymer composition described herein to the surface of the support substrate, thereby forming a photocleavable adhesive layer; adhering the device wafer to the support substrate by placing it on top of the adhesive layer; processing the device wafer, thereby curing the photocleavable adhesive layer; and irradiating the cured photocleavable adhesive layer with a wavelength of less than about 300 nm, thereby debonding the support substrate from the device wafer. In embodiments, the photocleavable adhesive layer is water soluble or water dispersible after irradiation. In embodiments, the photocleavable polymer or photocleavable polymer composition is applied via spincoating. In embodiments, the adhesive layer is irradiated for about 30 seconds to about 10 min. In embodiments, the adhesive layer is irradiated at an intensity of about 10 W/cm² to about 500 W/cm².

Other objects and advantages of this invention will become readily apparent from the ensuing description.

### BRIEF DESCRIPTION OF THE FIGURES

FIG. 1 shows a non-limiting, exemplary ¹H NMR of synthesized hydroxyethyl coumarin.

FIG. 2 shows a non-limiting, exemplary UV-Vis spectra of irradiated hydroxyethyl coumarin which contains a mixture of non-dimers (which peak absorbs at 322 nm) and dimers (peak absorbance from 281-289 nm)

FIG. 3 shows a non-limiting, exemplary ¹H NMR spectrum of the hydroxyethyl coumarin after dimerization. The spectra displayed here is a mixture of dimers and non-dimers, with about a 43% dimerization efficiency.

FIG. 4 shows non-limiting, exemplary photorheology of coumarin diacrylate and coumarin acrylate mixture with PEGA in a ratio of 50 wt. % and 75 wt. % PEGA to the coumarin acrylate mixtures.

FIG. 5 shows a non-limiting, exemplary schematic of the photochemical crosslinking of the coumarin diacrylate and coumarin acrylate mixture with PEGA and resulting photoreversible thermoset.

FIG. 6 shows a non-limiting, exemplary schematic of the photochemical crosslinking of the coumarin diacrylate with a monoacrylate where R=a water soluble or water dispersible substituent

### DETAILED DESCRIPTION OF THE INVENTION

Aspects of the disclosure are drawn towards the synthesis of new coumarin-dimer containing polymers for photoreversible polymers or polymer adhesives that exhibit water solubility or dispersibility after photocleavage.

Detailed descriptions of one or more embodiments are provided herein. It is to be understood, however, that the invention can be embodied in various forms. Therefore, specific details disclosed herein are not to be interpreted as limiting, but rather as a basis for the claims and as a representative basis for teaching one skilled in the art to employ the invention in any appropriate manner.

The singular forms “a”, “an” and “the” include plural reference unless the context clearly dictates otherwise. The use of the word “a” or “an” when used in conjunction with the term “comprising” in the claims and/or the specification can mean “one,” but it is also consistent with the meaning of “one or more,” “at least one,” and “one or more than one.”

Wherever any of the phrases “for example,” “such as,” “including” and the like are used herein, the phrase “and without limitation” is understood to follow unless explicitly stated otherwise. Similarly, “an example,” “exemplary” and the like are understood to be nonlimiting.

The term “substantially” allows for deviations from the descriptor that do not negatively impact the intended purpose. Descriptive terms are understood to be modified by the term “substantially” even if the word “substantially” is not explicitly recited.

The terms “comprising” and “including” and “having” and “involving” (and similarly “comprises”, “includes,” “has,” and “involves”) and the like are used interchangeably and have the same meaning. Specifically, each of the terms is defined consistent with the common United States patent law definition of “comprising” and is therefore interpreted to be an open term meaning “at least the following,” and is also interpreted not to exclude additional features, limitations, aspects, etc. Thus, for example, “a process involving steps a, b, and c” means that the process includes at least steps a, b and c. Wherever the terms “a” or “an” are used, “one or more” is understood, unless such interpretation is nonsensical in context.

As used herein, the term “about” can refer to approximately, roughly, around, or in the region of. When the term “about” is used in conjunction with a numerical range, it modifies that range by extending the boundaries above and below the numerical values set forth. In general, the term “about” is used herein to modify a numerical value above and below the stated value by a variance of 20 percent up or down (higher or lower). In embodiments, the term “about” can be denoted by [symbol] .

As used herein, the term “substantially the same” or “substantially” can refer to variability typical for a particular method is taken into account.

The terms “sufficient” and “effective”, as used interchangeably herein, can refer to an amount (e.g., mass, volume, dosage, concentration, and/or time period) needed to achieve one or more desired result(s).

Before explaining at least one embodiment of the disclosure in detail, it is to be understood that the disclosure is not necessarily limited in its application to the details set forth in the following description or exemplified by the examples. The disclosure can be used for other embodiments or of being practiced or carried out in various ways. Other compositions, compounds, methods, features, and advantages of the disclosure will be or become apparent to one having ordinary skill in the art upon examination of the following drawings, detailed description, and examples. All such additional compositions, compounds, methods, features, and advantages can be included within this description, and be within the scope of the disclosure.

The term “alkyl” refers to the radical of saturated aliphatic groups, including straight-chain alkyl groups, branched-chain alkyl groups, cycloalkyl (alicyclic) groups, alkyl-substituted cycloalkyl groups, and cycloalkyl-substituted alkyl groups.

In some embodiments, a straight chain or branched chain alkyl has 30 or fewer carbon atoms in its backbone (e.g., C₁-C₃₀ for straight chains, C₃-C₃₀ for branched chains), 20 or fewer, 12 or fewer, or 7 or fewer. Likewise, in some embodiments cycloalkyls have from 3-10 carbon atoms in their ring structure, e.g., have 5, 6 or 7 carbons in the ring structure. The term “alkyl” (or “lower alkyl”) as used throughout the specification, examples, and claims can include both “unsubstituted alkyls” and “substituted alkyls”, the latter of which refers to alkyl moieties having one or more substituents replacing a hydrogen on one or more carbons of the hydrocarbon backbone. Such substituents include, but are not limited to, halogen, hydroxyl, carbonyl (such as a carboxyl, alkoxycarbonyl, formyl, or an acyl), thiocarbonyl (such as a thioester, a thioacetate, or a thioformate), alkoxyl, phosphoryl, phosphate, phosphonate, a hosphinate, amino, amido, amidine, imine, cyano, nitro, azido, sulfhydryl, alkylthio, sulfate, sulfonate, sulfamoyl, sulfonamido, sulfonyl, heterocyclyl, aralkyl, or an aromatic or heteroaromatic moiety.

Unless the number of carbons is otherwise specified, “lower alkyl” as used herein can refer to an alkyl group, as defined herein, but having from one to ten carbons, or from one to six carbon atoms in its backbone structure. Likewise, “lower alkenyl” and “lower alkynyl” have similar chain lengths. In some embodiments, alkyl groups are lower alkyls. In some embodiments, a substituent described herein as alkyl can be a lower alkyl.

It will be understood by those skilled in the art that the moieties substituted on the hydrocarbon chain can themselves be substituted, if appropriate. For instance, the substituents of a substituted alkyl can include halogen, hydroxy, nitro, thiols, amino, azido, imino, amido, phosphoryl (including phosphonate and phosphinate), sulfonyl (including sulfate, sulfonamido, sulfamoyl and sulfonate), and silyl groups, as well as ethers, alkylthios, carbonyls (including ketones, aldehydes, carboxylates, and esters), —CF₃, —CN and the like. Cycloalkyls can be substituted in the same manner.

The term “heteroalkyl”, as used herein, can refer to straight or branched chain, or cyclic carbon-containing radicals, or combinations thereof, containing at least one heteroatom. Suitable heteroatoms include, but are not limited to, O, N, Si, P, Se, B, and S, wherein the phosphorous and sulfur atoms are optionally oxidized, and the nitrogen heteroatom is optionally quaternized. Heteroalkyls can be substituted as defined herein for alkyl groups.

The term “alkylthio” can refer to an alkyl group, as defined herein, having a sulfur radical attached thereto. In some embodiments, the “alkylthio” moiety is represented by one of —S-alkyl, —S-alkenyl, and —S-alkynyl. Representative alkylthio groups include methylthio, and ethylthio. The term “alkylthio” also encompasses cycloalkyl groups, alkene and cycloalkene groups, and alkyne groups. “Arylthio” refers to aryl or heteroaryl groups. Alkylthio groups can be substituted as defined herein for alkyl groups.

The terms “alkenyl” and “alkynyl”, refer to unsaturated aliphatic groups analogous in length and possible substitution to the alkyls described herein, but that contain at least one double or triple bond respectively. As used herein, the term “alkenyl” can refer to an unsaturated branched, straight-chain, or cyclic alkyl radical having at least one carbon-carbon double bond derived by the removal of one hydrogen atom from a single carbon atom of a parent alkene. The group can be in either the cis or trans conformation about the double bond(s). In embodiments described herein, the alkenyl group can be C₂-C₁₃ alkenyl. Non-limiting examples of alkenyl groups include ethenyl, propenyl, butenyl, pentenyl, hexenyl, octenyl, etc.

The terms “alkoxyl” or “alkoxy” as used herein can refer to an alkyl group, as defined herein, having an oxygen radical attached thereto. Representative alkoxyl groups include methoxy, ethoxy, propyloxy, and tert-butoxy. An “ether,” for example, can be two hydrocarbons covalently linked by an oxygen. Accordingly, the substituent of an alkyl that renders that alkyl an ether is or resembles an alkoxyl, such as can be represented by one of —O-alkyl, —O-alkenyl, and —O-alkynyl. Aroxy can be represented by —O-aryl or O-heteroaryl, wherein aryl and heteroaryl are as defined herein. The alkoxy and aroxy groups can be substituted as described herein for alkyl.

As used herein, the term “halogen” can refer to —F, —Cl, —Br or —I; the term “sulfhydryl” can refer to —SH; the term “hydroxyl” can refer to —OH; and the term “sulfonyl” can refer to —SO₂—.

The term “substituted” as used herein, can refer to permissible substituents of the compounds described herein. In the broadest sense, the permissible substituents include acyclic and cyclic, branched and unbranched, carbocyclic and heterocyclic, aromatic and nonaromatic substituents of organic compounds. Illustrative substituents include, but are not limited to, halogens, hydroxyl groups, or any other organic groupings containing any number of carbon atoms, for example 1-14 carbon atoms, and optionally include one or more heteroatoms such as oxygen, sulfur, or nitrogen grouping in linear, branched, or cyclic structural formats. Representative substituents include alkyl, substituted alkyl, alkenyl, substituted alkenyl, alkynyl, substituted alkynyl, phenyl, substituted phenyl, aryl, substituted aryl, heteroaryl, substituted heteroaryl, halo, hydroxyl, alkoxy, substituted alkoxy, phenoxy, substituted phenoxy, aroxy, substituted aroxy, alkylthio, substituted alkylthio, phenylthio, substituted phenylthio, arylthio, substituted arylthio, cyano, isocyano, substituted isocyano, carbonyl, substituted carbonyl, carboxyl, substituted carboxyl, amino, substituted amino, amido, substituted amido, sulfonyl, substituted sulfonyl, sulfonic acid, phosphoryl, substituted phosphoryl, phosphonyl, substituted phosphonyl, polyaryl, substituted polyaryl, C3-C20 cyclic, substituted C3-C20 cyclic, heterocyclic, substituted heterocyclic, amino acid, peptide, and polypeptide groups. As used herein in reference to an “R” group, the name used to describe said “R” group can be the chemical name prior to the removal of a hydrogen. For example, wherein “R” is described as an “alkane” can refer to an “alkyl” group.

Heteroatoms such as nitrogen can have hydrogen substituents and/or any permissible substituents of organic compounds described herein which satisfy the valences of the heteroatoms. It is understood that “substitution” or “substituted” includes the implicit proviso that such substitution is in accordance with permitted valence of the substituted atom and the substituent, and that the substitution results in a stable compound, i.e., a compound that does not spontaneously undergo transformation such as by rearrangement, cyclization, elimination, etc.

In a broad aspect, the permissible substituents include acyclic and cyclic, branched and unbranched, carbocyclic and heterocyclic, aromatic and nonaromatic substituents of organic compounds. Illustrative substituents include, for example, those described herein. The permissible substituents can be one or more and the same or different for appropriate organic compounds. The heteroatoms such as nitrogen can have hydrogen substituents and/or any permissible substituents of organic compounds described herein which satisfy the valencies of the heteroatoms.

In various aspects, the substituent can be selected from alkoxy, aryloxy, alkyl, alkenyl, alkynyl, amide, amino, aryl, arylalkyl, carbamate, carboxy, cyano, cycloalkyl, ester, ether, formyl, halogen, haloalkyl, heteroaryl, heterocyclyl, hydroxyl, ketone, nitro, phosphate, sulfide, sulfinyl, sulfonyl, sulfonic acid, sulfonamide, and thioketone, each of which optionally is substituted with one or more suitable substituents. In some embodiments, the substituent is selected from alkoxy, aryloxy, alkyl, alkenyl, alkynyl, amide, amino, aryl, arylalkyl, carbamate, carboxy, cycloalkyl, ester, ether, formyl, haloalkyl, heteroaryl, heterocyclyl, ketone, phosphate, sulfide, sulfinyl, sulfonyl, sulfonic acid, sulfonamide, and thioketone, wherein each of the alkoxy, aryloxy, alkyl, alkenyl, alkynyl, amide, amino, aryl, arylalkyl, carbamate, carboxy, cycloalkyl, ester, ether, formyl, haloalkyl, heteroaryl, heterocyclyl, ketone, phosphate, sulfide, sulfinyl, sulfonyl, sulfonic acid, sulfonamide, and thioketone can be further substituted with one or more suitable substituents.

Examples of substituents include, but are not limited to, halogen, azide, alkyl, aralkyl, alkenyl, alkynyl, cycloalkyl, hydroxyl, alkoxyl, amino, nitro, sulfhydryl, imino, amido, phosphonate, phosphinate, carbonyl, carboxyl, silyl, ether, alkylthio, sulfonyl, sulfonamido, ketone, aldehyde, thioketone, ester, heterocyclyl, —CN, aryl, aryloxy, perhaloalkoxy, aralkoxy, heteroaryl, heteroaryloxy, heteroarylalkyl, heteroaralkoxy, azido, alkylthio, oxo, acylalkyl, carboxy esters, carboxamido, acyloxy, aminoalkyl, alkylaminoaryl, alkylaryl, alkylaminoalkyl, alkoxyaryl, arylamino, aralkylamino, alkylsulfonyl, carboxamidoalkylaryl, carboxamidoaryl, hydroxyalkyl, haloalkyl, alkylaminoalkylcarboxy, aminocarboxamidoalkyl, cyano, alkoxyalkyl, perhaloalkyl, arylalkyloxyalkyl, and the like. In some embodiments, the substituent is selected from cyano, halogen, hydroxyl, and nitro.

As used herein, the term hydroxyalkyl can refer to a hydroxy terminated alkyl. For example, the hydroxyalkyl can be any hydroxyalkyl known in the art. In embodiments the hydroxyalkyl can be C₁-C₁₂ hydroxyalkyl. For example, the hydroxyalkyl can be hydroxymethyl, hydroxyethyl, hydroxypropyl, hydroxybutyl, hydroxypentyl, hydroxyhexyl, etc.

As used herein, the term “residue” refers to an organic structure (e.g. a vinyl residue, an a diacid residue, or a diester residue, and the like) incorporated into the backbone of a polymer through polymerization of the corresponding monomer, or through the reaction of one or more starting materials to create a functionalized starting material or monomer. For example, the polymerization or reaction can be a ring opening polymerization, a polycondensation reaction, a condensation reaction, or an esterification reaction, and the like. It will be understood by persons of ordinary skill in the art that the residues of the monomers, starting materials, or structures described herein can be derived from the parent compound or a derivative of the parent compound. Structures or chemicals described herein as residues will be well understood by the person skilled in the art. For example, as used herein, it will be well understood by the person of ordinary skill in the art that the term acrylate residue can be used to represent the reaction product of a polyethylene glycol monoacrylate, a hydroxyethyl acrylate, a methacrylic acid, or a methacrylate, and the like.

Temporary bonding, debonding adhesives often undergo heat cycles during the wafer assembly process that can lead to cracking and warpage. For example, thermal bonding, debonding (TBDB) often requires elevated temperatures and heat cycling, which can lead to cracking or warping of the processed device. Described herein are new photoreversible polymers and monomers for producing the same. Moreover, the compositions described herein solve an additional unmet need by being water dispersible or water soluble before or after UV irradiation or both. In some embodiments, the composition can be water soluble or water insoluble. However, if the composition is insoluble, it can become water soluble or water dispersible upon depolymerization. In embodiments, one of ordinary skill in the art can select co-monomers with desired properties, including water solubility.

The compositions described herein can be synthesized from 7-hydroxycoumarin dimer derivatives. However, the phenolic moiety of 7-hydroxy coumarin can act as a radical scavenger which hinders dimerization. Therefore, aspects of the disclosure are drawn towards functionalizing the 7-hydroxy coumarin prior to dimerization, thereby increasing dimerization yields. Specifically, aspects of the disclosure are drawn towards the conversion of the phenol to an ether containing an alkyl chain (e.g., C1-20 in length) with a terminal substituent reactive toward step growth or chain growth polymerizations.

In embodiments, the disclosure is drawn towards a composition comprising the monomer residue of Formula (I),

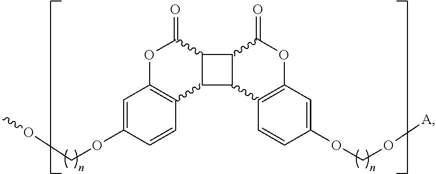

wherein n=1-20; and A is a polyester, a polyurethane, a polyacrylate, a water-soluble polymer, or a copolymer. In some embodiments, the polyester comprises at least one diacid residue, at least one diester residue, or a combination thereof. In some embodiments, the polyurethane comprises at least one diisocyanate monomer residue, at least one diester residue, or a combination thereof. In some embodiments, the polyacrylate comprises at least one acrylate monomer residue, at least one vinyl monomer residue, or a combination thereof.

As used herein, the term “reactive moiety” can refer to any group that is susceptible to reactivity with crosslinking. In embodiments, the reactive moiety can be any reactive moiety known in the art by one of ordinary skill in the art. For example, the reactive moiety can be any group capable of crosslinking as known in the art.

Aspects of the disclosure are drawn toward a polymer or polymer composition comprising a repeat unit residue of the monomer of Formula (I),

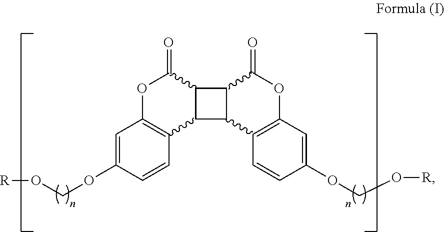

and at least one comonomer, wherein n can be equal to 1-20, and R can be equal to H, a vinyl residue, an epoxy residue, an acrylate residue, a diacid residue, a diester residue, a diisocyanate residue, a diamide residue, a dithiol residue, or a diamine residue. In some embodiments, R can be any reactive moiety. As used herein, the term “reactive moiety” can refer to any group that is susceptible to reactivity (e.g. linear polymerization, branched polymerization, or crosslinking, and the like). In embodiments, the reactive moiety can be any reactive moiety known in the art by one of ordinary skill in the art. For example, the reactive moiety can be any group capable of crosslinking as known in the art.

As used herein, a wavy bond can indicate any combination of isomers. For example,

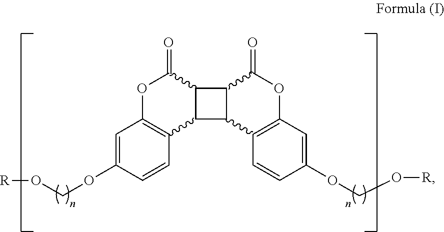

can refer to a mixture of:

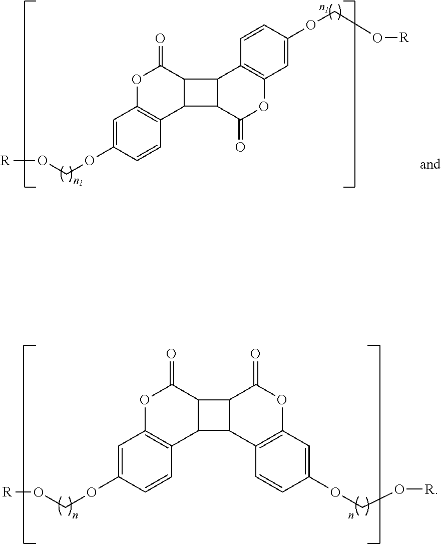

In embodiments, the isomers can be present in a ratio of about 0:100, 1:99, about 5:95, about 10:90, about 15:85, about 20:80, about 25:75, about 30:70, about 35:65, about 40:60, about 45:55, about 50:50, about 55:45, about 60:40, about 65:35, about 70:30, about 85:15, about 80:20, about 85:15, about 90:10, about 95:5, or about 99:1, or about 100:0.

In some embodiments, the vinyl residue is selected from an N-vinylpyrrolidone residue, an acrylamide residue, an acrylic acid residue, or

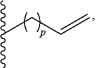

wherein p can be 0-10. In some embodiments, the epoxy residue is

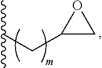

wherein m can be to 1-4. In some embodiments, the acrylate residue can be selected from the group consisting of a glycol acrylate residue, a hydroxyethyl acrylate residue, or

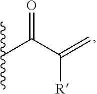

wherein R′ can be H, or C₁-C₃ alkyl. In some embodiments, the diacid residue is

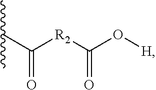

wherein R₂ can be C₁-C₁₆ alkylene, C₁-C₂₀ alkenyl, C₆-C₈ arylene, naphthylene, oxo, or thioalkylene. In some embodiments, the diester residue is

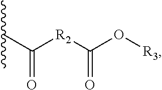

wherein R₂ can be C₁-C₁₆ alkylene, C₁-C₂₀ alkenyl, C₆-C₈ arylene, naphthylene, oxo, or thioalkylene, and R₃ can be H or C₁-C₆ alkyl. In some embodiments, the diisocyanate residue is

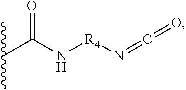

wherein R₄ can be alkylene, branched alkylene, cycloalkylene, branched cycloalkylene, heterocycloalkylene, arylene, naphthylene, alkenyl, oxo, or thioalkylene. In some embodiments the dithiol residue is:

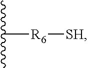

wherein R₆ is equal to C₂-C₁₂ alkylene or a substituted C₂-C₁₂ alkylene, wherein the substituents are selected from an ether (—O—) or a carbonyl (—C(═O)—) In some embodiments, the diamine residue is:

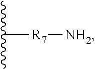

wherein R₇ is equal to C₂-C₁₂ alkylene, C₂-C₁₂ branched alkylene, C₆-C₁₄ arylene, biphenylene, hetero-arylene, C₁-C₁₂ hetero-alkylene, or substituted derivatives thereof, wherein the substituents are independently selected from C₁-C₆ alkyl, C₁-C₆ alkoxy, halo, ether (—O—), carbonyl (—C(═O)—), sulfone (—SO₂—), or combinations thereof. In some embodiments, the diamide residue is:

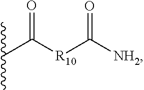

wherein R₁₀ is equal to C₂-C₁₂ alkylene.

As used herein, the structural feature [symbol] is understood to represent the point of connection of the as described residue. In embodiments of the polymer or polymer composition described herein, wherein R is equal to H, the at least one co-monomer residue can be a diacid monomer residue of

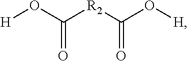

wherein R₂ can be C₁-C₁₆ alkylene, C₁-C₂₀ alkenyl, C₆-C₈ arylene, naphthylene, —O—, —C(═O)—, or thioalkylene. In some embodiments, wherein R is equal to H, the at least one comonomer can be a diester residue of

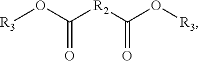

wherein R₂ can be C₁-C₁₆ alkylene, C₁-C₂₀ alkenyl, C₆-C₈ arylene, naphthylene, —O—, —C(═O)—, or thioalkylene, and R₃ can be H, C₁-C₆ alkyl, or phenyl. In some embodiments, wherein R is equal to H, the at least one comonomer can be a diisocyanate monomer residue of

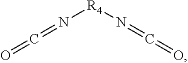

wherein R₄ can be alkylene, branched alkylene, cycloalkylene, branched cycloalkylene, hetero-cycloalkylene, arylene, naphthylene, alkenylene, —O—, —C(═O)—, or thioalkylene.

In some embodiments wherein R is equal to H, the comonomer can be any allowable combination of the comonomers as described herein.

In embodiments of the polymer or polymer composition described herein, wherein R is equal to an epoxy residue, the at least one co-monomer residue can be a diisocyanate monomer residue of

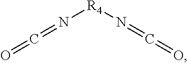

wherein R₄ can be alkylene, branched alkylene, cycloalkylene, branched cycloalkylene, hetero-cycloalkylene, arylene, naphthylene, alkenylene, —O—, —C(═O)—, or thioalkylene. In some embodiments, wherein R is equal to an epoxy residue, the at least one comonomer can be a diamine monomer residue of:

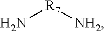

wherein R₇ is equal to C₂-C₁₂ alkylene, C₂-C₁₂ branched alkylene, C₆-C₁₄ arylene, biphenylene, hetero-arylene, C₁-C₁₂ hetero-alkylene, or substituted derivatives thereof, wherein the substituents are independently selected from C₁-C₆ alkyl, C₁-C₆ alkoxy, halo, ether (—O—), carbonyl (—C(═O)—), sulfone (—SO₂—), or combinations thereof. In some embodiments, wherein R is equal to an epoxy residue, the at least one comonomer can be a dithiol monomer residue of:

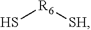

wherein R₆ is equal to C₂-C₁₂ alkylene or a substituted C₂-C₁₂ alkylene, wherein the substituents are selected from an ether (—O—) or a carbonyl (—C(═O)—). In some embodiments, wherein R is equal to an epoxy residue, the at least one comonomer can be a diol monomer residue of:

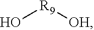

wherein R₉ is equal to C₂-C₁₂ alkylene, branched C₃-C₁₂ alkylene, poly(alkylene)oxy alkylene, cycloalkylene, non-phenolic arylalkylene, or ester-containing alkylene. In some embodiments, wherein R is an epoxy residue, the comonomer can be any allowable combination of the comonomers as described herein.

In embodiments of the polymer or polymer composition described herein, wherein R is equal to a vinyl residue or an acrylate residue, the at least one comonomer can be

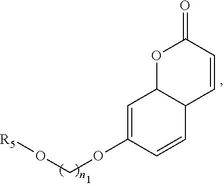

wherein nᵢ can be 1-20, and R₅ can be an acrylate residue, or a vinyl residue. In some embodiments, wherein R is equal to a vinyl residue or an acrylate residue, the at least one comonomer can be an acrylate monomer residue, a vinyl monomer residue, or a combination thereof. In some embodiments, wherein R is equal to a vinyl residue or an acrylate residue, the at least one comonomer can be a diamine monomer residue of:

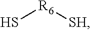

wherein R₆ is equal to C₂-C₁₂ alkylene or a substituted C₂-C₁₂ alkylene, wherein the substituents are selected from an ether (—O—) or a carbonyl (—C(═O)—). In some embodiments, wherein R is equal to a vinyl residue or an acrylate residue, the at least one comonomer can be a dithiol monomer residue of:

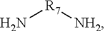

wherein R₇ is equal to C₂-C₁₂ alkylene, C₂-C₁₂ branched alkylene, C₆-C₁₄ arylene, biphenylene, hetero-arylene, C₁-C₁₂ hetero-alkylene, or substituted derivatives thereof, wherein the substituents are independently selected from C₁-C₆ alkyl, C₁-C₆ alkoxy, halo, ether (—O—), carbonyl (—C(═O)—), sulfone (—SO₂—), or combinations thereof.

In embodiments of the polymer or polymer composition described herein, wherein R is equal a diacid residue, the at least one co-monomer residue can be a diacid monomer residue of

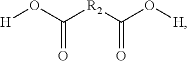

wherein R₂ can be C₁-C₁₆ alkylene, C₁-C₂₀ alkenyl, C₆-C₈ arylene, naphthylene, —O—, —C(═O)—, or thioalkylene. In some embodiments, wherein R is equal to a diester residue, the at least one comonomer can be a diisocyanate monomer residue of

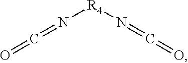

wherein R₄ can be alkylene, branched alkylene, cycloalkylene, branched cycloalkylene, hetero-cycloalkylene, arylene, naphthylene, alkenylene, —O—, —C(═O)—, or thioalkylene. In some embodiments, wherein R is equal to a diacid residue, the at least one comonomer can be a diamine monomer residue of:

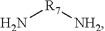

wherein R₇ is equal to C₂-C₁₂ alkylene, C₂-C₁₂ branched alkylene, C₆-C₁₄ arylene, biphenylene, hetero-arylene, C₁-C₁₂ hetero-alkylene, or substituted derivatives thereof, wherein the substituents are independently selected from C₁-C₆ alkylene, C₁-C₆ alkoxy, halo, ether (—O—), carbonyl (—C(═O)—), sulfone (—SO₂—), or combinations thereof. In some embodiments, wherein R is equal to a diacid residue, the at least one comonomer can be a dithiol monomer residue of:

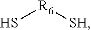

wherein R₆ is equal to C₂-C₁₂ alkylene or a substituted C₂-C₁₂ alkylene, wherein the substituents are selected from an ether (—O—) or a carbonyl (—C(═O)—). In some embodiments, wherein R is equal to a diacid residue, the at least one comonomer can be a diol monomer residue of:

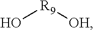

wherein R₉ is equal to C₂-C₁₂ alkylene, branched C₃-C₁₂ alkylene, poly(alkylene)oxy alkylene, cycloalkylene, non-phenolic arylalkylene, or ester-containing alkylene. In some embodiments, wherein R is equal to a diacid residue, the comonomer can be any allowable combination of the comonomers as described herein.

In embodiments of the polymer or polymer composition described herein, wherein R is equal to a diester residue, the at least one co-monomer can be a diester residue of

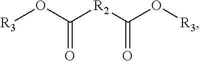

wherein R₂ can be C₁-C₁₆ alkylene, C₁-C₂₀ alkenyl, C₆-C₈ arylene, naphthylene, —O—, —C(═O)—, or thioalkylene, and R₃ can be H, C₁-C₆ alkyl, or phenyl. In some embodiments, wherein R is equal to a diester residue, the at least one comonomer can be a diamine monomer residue of:

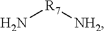

wherein R₇ is equal to C₂-C₁₂ alkylene, C₂-C₁₂ branched alkylene, C₆-C₁₄ arylene, biphenylene, hetero-arylene, C₁-C₁₂ hetero-alkylene, or substituted derivatives thereof, wherein the substituents are independently selected from C₁-C₆ alkyl, C₁-C₆ alkoxy, halo, ether (—O—), carbonyl (—C(═O)—), sulfone (—SO₂—), or combinations thereof. In some embodiments, wherein R is equal to a diester residue, the at least one comonomer can be a dithiol monomer residue of:

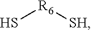

wherein R₆ is equal to C₂-C₁₂ alkylene or a substituted C₂-C₁₂ alkylene, wherein the substituents are selected from an ether (—O—) or a carbonyl (—C(═O)—). In some embodiments, wherein R is equal to a diester residue, the at least one comonomer can be a diol monomer residue of:

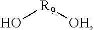

wherein R₉ is equal to C₂-C₁₂ alkylene, branched C₃-C₁₂ alkylene, poly(alkylene)oxy alkylene, cycloalkylene, non-phenolic arylalkylene, or ester-containing alkylene. In some embodiments wherein R is equal to a diester residue, the comonomer can be any allowable combination of the comonomers as described herein.

In embodiments of the polymer or polymer composition described herein, wherein R is equal to a diisocyanate residue, the at least one co-monomer can be a diacid monomer residue of

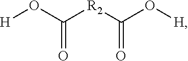

wherein R₂ can be C₁-C₁₆ alkylene, C₁-C₂₀ alkenyl, C₆-C₅ arylene, naphthylene, —O—, —C(═O)—, or thioalkylene. In some embodiments, wherein R is equal to a diisocyanate residue, the at least one comonomer can be a diamine monomer residue of:

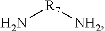

wherein R₇ is equal to C₂-C₁₂ alkylene, C₂-C₁₂ branched alkylene, C₆-C₁₄ arylene, biphenyl, hetero-arylene, C₁-C₁₂ hetero-alkylene, or substituted derivatives thereof, wherein the substituents are independently selected from C₁-C₆ alkyl, C₁-C₆ alkoxy, halo, ether (—O—), carbonyl (—C(═O)—), sulfone (—SO₂—), or combinations thereof. In some embodiments, wherein R is equal to a diisocyanate residue, the at least one comonomer can be a dithiol monomer residue of:

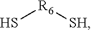

wherein R₆ is equal to C₂-C₁₂ alkylene or a substituted C₂-C₁₂ alkylene, wherein the substituents are selected from an ether (—O—) or a carbonyl (—C(═O)—). In some embodiments, wherein R is equal to a diisocyante residue, the at least one comonomer can be a diol monomer residue of:

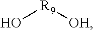

wherein R₉ is equal to C₂-C₁₂ alkylene, branched C₃-C₁₂ alkylene, poly(alkylene)oxy alkylene, cycloalkylene, non-phenolic arylalkylene, or ester-containing alkylene. In some embodiments wherein R is equal to a diisocyanate residue, the comonomer can be any allowable combination of the comonomers as described herein.

In some embodiments, wherein R is equal to a diamine residue, the at least one co-monomer residue can be an acrylate monomer residue. In some embodiments, wherein R is equal to a diamine residue, the at least one co-monomer residue can be a diisocyanate residue of:

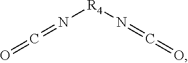

wherein R₄ is equal to alkylene, branched alkylene, cycloalkylene, branched cycloalkylene, hetero-cycloalkylene, arylene, naphthylene, alkenylene, —O—, —C(═O)—, or thioalkylene. In some embodiments, wherein R is equal to a diamine residue, the at least one co-monomer residue can be a diacid monomer residue of:

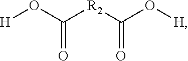

wherein R₂ is equal to C₁-C₁₆ alkylene, C₁-C₂₀ alkenyl, C₆-C₈ arylene, naphthylene, —O—, —C(═O)—, or thioalkylene. In some embodiments, wherein R is equal to a diamine residue, the at least one co-monomer residue can be a diester monomer residue of:

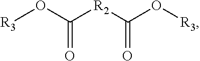

wherein R₂ is equal to C₁-C₁₆ alkylene, C₁-C₂₀ alkenyl, C₆-C₈ arylene, naphthylene, —O—, —C(═O)—, or thioalkylene, and R₃=H, C₁-C₆ alkyl, or phenyl. In some embodiments wherein R is equal to a diamine residue, the comonomer can be any allowable combination of the comonomers as described herein.

In some embodiments, wherein R is equal to a dithiol residue, the at least one co-monomer residue can be an acrylate monomer residue. In some embodiments, wherein R is equal to a dithiol residue, the at least one co-monomer residue can be a vinyl monomer residue. In some embodiments, wherein R is equal to a dithiol residue, the at least one co-monomer residue can be a diacid monomer residue of:

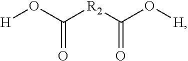

wherein R₂ is equal to C₁-C₁₆ alkylene, C₁-C₂₀ alkenyl, C₆-C₈ arylene, naphthylene, —O—, —C(═O)—, or thioalkylene. In some embodiments, wherein R is equal to a dithiol residue, the at least one co-monomer residue can be a diester monomer residue of:

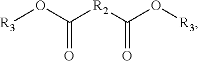

wherein R₂ is equal to C₁-C₁₆ alkylene, C₁-C₂₀ alkenyl, C₆-C₈ arylene, naphthylene, —O—, —C(═O)—, or thioalkylene, and R₃=H, C₁-C₆ alkyl, or phenyl. In some embodiments wherein R is equal to a dithiol residue, the comonomer can be any allowable combination of the comonomers as described herein.

In some embodiments, wherein R is equal to a diamine residue, the at least one co-monomer residue can be a diamine monomer residue of

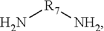

wherein R₇ is equal to C₂-C₁₂ alkylene, C₂-C₁₂ branched alkylene, C₆-C₁₄ aryl, biphenyl, heteroaryl, C₁-C₁₂ hetero-alkylene, or substituted derivatives thereof, wherein the substituents are independently selected from C₁-C₆ alkyl, C₁-C₆ alkoxy, halo, ether (—O—), carbonyl (—C(═O)—), sulfone (—SO₂—), or combinations thereof. In some embodiments, wherein R is equal to a diamine residue, the at least one co-monomer residue can be a diol monomer residue of:

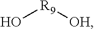

Wherein R₉ is equal to C₂-C₁₂ alkylene, branched C₃-C₁₂ alkylene, poly(alkylene)oxy alkylene, cycloalkylene, non-phenolic arylalkylene, or ester-containing alkylene.

In some embodiments, wherein R is equal to a diamine residue, the at least one co-monomer residue can be a diisocyanate residue of:

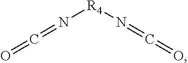

wherein R4 is equal to alkylene, branched alkylene, cycloalkylene, branched cycloalkylene, hetero-cycloalkylene, arylene, naphthylene, alkenylene, —O—, —C(═O)—, or thioalkylene. In some embodiments, wherein R is equal to a diamine residue, the comonomer can be any allowable combination of the comonomers as described herein.

In embodiments, the compositions described herein can undergo photocleavage at about 270 nm to about 300 nm. For example, the composition can undergo photocleavage about 285 nm. In embodiments the compositions described herein can undergo photodimerization at about 310 nm to about 340 nm, or a combination thereof. The orthogonality of the photocleavage wavelengths and photodimerization wavelengths can be beneficial as the photo-reversal wavelengths do not overlap with other lithographic processes during the wafer level assembly.

In embodiments, the compositions described herein can be water soluble or water dispersible. As used herein, the term “water soluble” can refer to a compound or composition that dissolves in water. As used herein, the term “water dispersible” can refer to a compound or composition that is not fully solubilized by water but can be spread or distributed in water. For example, the water dispersible compositions can form a suspension in the water. In embodiments, the compound or composition that is dispersed in water can be washed away by water. For example, a water dispersible compound or composition can be removed by application of water rather than requiring an organic solvent. For example, in embodiment, removal of the water dispersible compound or composition does not require heat, organic solvent, or any combination thereof.

In embodiments, the repeat unit residue of the monomer of Formula I can be present in about 1 mol. % to about 99 mol. % of the at least one co-monomer. In embodiments, the repeat unit residue of the monomer of Formula I can be present in about 5 mol. % to about 75 mol. %. For example, the composition of Formula I can be present in about 1 mol. %, about 2 mol. %, about 3 mol. %, about 4 mol. %, about 5 mol. %, about 6 mol. %, about 7 mol. %, about 8 mol. %, about 9 mol. %, about 10 mol. %, about 12.5 mol. %, about 15 mol. %, about 17.5 mol. %, about 20 mol. %, about 22.5 mol. %, about 25 mol. %, about 27.5 mol. %, about 30 mol. %, about 32.5 mol. %, about 35 mol. %, about 37.5 mol. %, about 40 mol. %, about 42.5 mol. %, about 45 mol. %, about 47.5 mol. %, about 50 mol. %, about 55 mol. %, about 60 mol. %, about 65 mol. %, about 70 mol. %, about 75 mol. %, about 80 mol. %, about 85 mol. %, about 90 mol. %, about 95 mol. %, or about 99 mol. %.

In embodiments, a polymer or polymer composition described herein can have an Mₙ of about 1000 g/mol to about 250,000 g/mol. In some embodiments, the polymer or polymer composition described herein can have an Mₙ of about 10,000 g/mol to about 40,000 g/mol. For example, the composition can comprise an Mₙ of less than about 1000 g/mol, about 1100 g/mol, about 1200 g/mol, about 1300 g/mol, about 1400 g/mol, about 1500 g/mol, about 1750 g/mol, about 2000 g/mol, about 2250 g/mol, about 2500 g/mol, about 3000 g/mol, about 3500 g/mol, about 4000 g/mol, about 4500 g/mol, about 5000 g/mol, about 5500 g/mol, about 6000 g/mol, about 6500 g/mol, about 7000 g/mol, about 8000 g/mol, about 9000 g/mol, about 10,000 g/mol, about 11,000 g/mol, about 12,000 g/mol, about 13,000 g/mol, about 14,000 g/mol, about 15,000 g/mol, about 16,000 g/mol, about 17,000 g/mol, about 18,000 g/mol, about 20,000 g/mol, about 22,500 g/mol, about 25,000 g/mol, about 27,500 g/mol, about 30,000 g/mol, about 35,000 g/mol, about 40,000 g/mol, about 45,000 g/mol, about 50,000 g/mol, about 55,000 g/mol, 60,000 g/mol, about 65,000 g/mol, about 70,000 g/mol, about 75,000 g/mol, about 80,000 g/mol, about 85,000 g/mol, about 90,000 g/mol, about 100,000 g/mol, about 110,000 g/mol, about 120,000 g/mol, about 130,000 g/mol, about 140,000 g/mol, about 150,000 g/mol, about 160,000 g/mol, about 170,000 g/mol, about 180,000 g/mol, about 190,000 g/mol, about 200,000 g/mol, about 210,000 g/mol, about 220,000 g/mol, about 230,000 g/mol, about 240,000 g/mol, about 250,000 g/mol, about 260,000 g/mol, about 270,000 g/mol, about 280,000 g/mol, about 290,000 g/mol, about 300,000 g/mol, or greater than 300,000 g/mol. In embodiments, the composition includes, but is not limited to, a polymer or polymer material.

In embodiments, a polymer or polymer composition described herein can be a polyester, a polyurethane, co-polymer thereof, or a cross-linked polymer or polymer composition thereof. In embodiments, the diacid or diester can be any diacid or diester as known in the art.

In embodiments, the polymer or polymer composition described herein can be a bond-debond adhesive. In embodiments, the polymer or polymer composition described herein can be a photocleavable polymer or photocleavable polymer composition.

In some non-limiting embodiments, for example, the diacid described herein can include but is not limited to oxalic acid, malonic acid, succinic acid, glutaric acid, adipic acid, picric acid, phthalic acid, isophthalic acid, terephthalic acid, biphenyl-2,2′-dicarboxylic acid, or 2,6-naphthalenedicarboxylic acid. In some non-limiting embodiments, for example, the diester described herein can include but is not limited to the diesters of the dicarboxylic acids described herein.

In some exemplary embodiments, the diisocyanate as described herein can include but is not limited to methylene diphenyl diisocyanate, toluene diisocyanate, 1,6-hexamethylene diisocyanate, isophorone diisocyanate, methylene bis-cyclohexylisocyanate, 1,5-naphtalene diisocyanate, 1,4-phenylene diisocyanate, tetramethylxylene diisocyanate, trans-1,4-cyclohexylene diisocyanate, 3,3′-Dimethyl-4,4′-biphenylene diisocyanate,

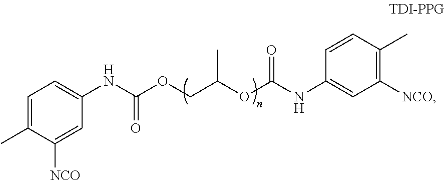

PEG isocyanate,

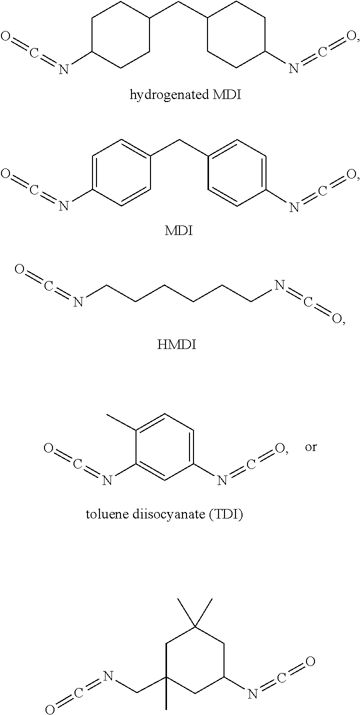

isophorone diisocyanate, or a combination thereof.

In some embodiments, the acrylate residue can include, but is not limited to, poly(ethylene glycol monoacrylate) (PEGA), hydroxyethyl acrylate, or a combination thereof. In some embodiments, the vinyl residue can be an acrylic acid, methacrylic acid, N-vinyl pyrrolidone, acrylamide, or a combination thereof.

In some exemplary embodiments, the dithiols and diothiol residues as described herein can include but are not limited to 1,2-ethanedithiol, 1,3-propanedithiol, 1,4-butanedithiol, 1,5-pentanedithiol, 1,6-hexanedithiol, 1,7-heptanedithiol, 1,8-octanedithiol, 1,9-nonanedithiol, 1,10-decanedithiol, 1,11-undecanedithiol, and 1,12-dodecanedithiol.

In some exemplary embodiments, the diamines and diamine residues as described herein can include but are not limited to aliphatic diamines and aromatic diamines. For example, the aliphatic diamines can be C₂-C₁₂ aliphatic diamines such as 1,2-diaminoethane, 1,3-propanediamine, 1,4-butanediamine, 1,5-pentanediamine, 1,6-hexanediamine, 1,7-heptanediamine, 1,8-octanediamine, 1,9-nonanediamine, 1,10-decanediamine, 1,11-undecanediamine, or 1,12-dodecanediamine. In embodiments, the aromatic diamine or diamine residues can be phenylenediamines, biphenyl diamines, diphenyl diamines, tolylenediamines, xylylenediamines, naphthalenediamines, heteroaromatic diamines, and substituted derivatives thereof. For example, the diamine or diamine residues can be 1,2-phenylenediamine, 1,3-phenylenediamine, 1,4-phenylenediamine, benzidine, diaminodiphenylmethane (MDA), diaminodiphenyl ether (ODA), diaminodiphenyl sulfone (DDS), toluenediamine, o-xylylenediamine, m-xylylenediamine, 1,5-naphthalenediamine, 1,8-naphthalenediamine, 2,6-naphthalenediamine, 2,6-diaminopyridine, 3,5-diaminopyridine, 2,5-diaminopyrimidine, 3,3′-diaminobenzidine, 4,4′-diamino-3,3′-dimethyldiphenylmethane, 4,4′-diamino-3,3′-diethyldiphenylmethane, or dimethoxybenzidine.

In some exemplary embodiments, the diamides as described herein can include but are not limited to C₂-C₁₂ aliphatic diamides. For example, the diamide or diamide residue can be selected from oxamide, malonamide, succinamide, glutaramide, adipamide, pimelamide, suberamide, azelamide, sebacamide, undecanediamide, dodecanediamide.

In some exemplary embodiments, the diols or diol residues as described herein can include but are not limited to aliphatic diols, hydroxyalkyl-substituted aromatic diols, cycloaliphatic diols, hydroxyalkyl aromatic diols, aromatic diols, a diol ester, or polyether diols. For example, the diol or diol residues can include, but are not limited to ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 2-methyl-1,3-propanediol, neopentyl glycol (2,2-dimethyl-1,3-propanediol), diethylene glycol, triethylene glycol, and dipropylene glycol, 1,4-cyclohexanedimethanol (CHDM), 1,4-cyclohexanediol, isosorbide, isomannide, isoidide, bis(2-hydroxyethyl) terephthalate, PPG diols, or PEG diols.

Aspects of the disclosure are drawn towards an adhesive composition comprising any composition described herein. The type of adhesive can be determined by one of ordinary skill in the art based on the application. For example, polyesters based on terephthalic acid and ethylene glycol can be used in hot-melt adhesives. Additionally, polyurethanes based on methylene diphenyl diisocyanate and 1,4-butane diol are common polyurethane structural adhesives.

Aspects of the disclosure are drawn towards a method of temporarily bonding a support substrate to a semiconductor wafer for processing. In embodiments, the method comprises obtaining a device wafer and a support substrate; applying a photocleavable adhesive composition, a photocleavable polymer, or a photocleavable polymer composition as described herein to the surface of the support substrate, thereby forming a photocleavable adhesive layer; adhering the device wafer to the support substrate by placing it on top of the adhesive layer; processing the device wafer, thereby curing the photocleavable adhesive layer; and irradiating the adhesive layer with a wavelength of less than about 300 nm, thereby debonding the support substrate from the device wafer. In embodiments, the adhesive layer is water soluble or water dispersible after irradiation. In embodiments, the photocleavable adhesive polymer is applied via spincoating.

In embodiments, the adhesive layer can be irradiated for less than about 30 seconds to about 30 minutes. For example, the adhesive layer can be irradiated for about 5 seconds, about 10 seconds, about 20 seconds, about 30 seconds, about 1 min, about 2 min, about 3 min, about 4 min, about 5 min, about 6 min, about 7 min, about 8 min, about 9 min, about 10 min, about 15 min, about 20 min, about 25 min, about 30 min, or greater than about 30 min. In some embodiments, the adhesive layer is irradiated for less than about 10 minutes.

In embodiments, the adhesive layer is irradiated at an intensity of about 10 W/cm² to about 500 W/cm². For example, the intensity can comprise about 0.5 W/cm², about 1 W/cm², about 2 W/cm², about 3 W/cm², about 4 W/cm², about 5 W/cm², about 7.5 W/cm², about 10 W/cm², about 12.5 W/cm², about 15 W/cm², about 17.5 W/cm², about 20 W/cm², about 22.5 W/cm², about 25 W/cm², about 27.5 W/cm², about 30 W/cm², about 35 W/cm², about 40 W/cm², about 45 W/cm², about 50 W/cm², about 55 W/cm², about 60 W/cm², about 65 W/cm², about 70 W/cm², about 75 W/cm², about 80 W/cm², about 85 W/cm², about 90 W/cm², about 95 W/cm², about 100 W/cm², about 105 W/cm², about 110 W/cm², about 120 W/cm², about 125 W/cm², about 127.5 W/cm², about 130 W/cm², about 132.5 W/cm², about 135 W/cm², about 137.5 W/cm², about 140 W/cm², about 142.5 W/cm², about 145 W/cm², about 147.5 W/cm², about 150 W/cm², about 155 W/cm², about 160 W/cm², about 165 W/cm², about 170 W/cm², about 175 W/cm², about 180 W/cm², about 185 W/cm², about 190 W/cm², about 195 W/cm², about 200 W/cm², about 205 W/cm², about 210 W/cm², about 220 W/cm², about 225 W/cm², about 227.5 W/cm², about 230 W/cm², about 232.5 W/cm², about 235 W/cm², about 237.5 W/cm², about 240 W/cm², about 242.5 W/cm², about 245 W/cm², about 247.5 W/cm², about 250 W/cm², about 255 W/cm², about 260 W/cm², about 265 W/cm², about 270 W/cm², about 275 W/cm², about 280 W/cm², about 285 W/cm², about 290 W/cm², about 295 W/cm², about 300 W/cm², about 305 W/cm², about 310 W/cm², about 320 W/cm², about 325 W/cm², about 327.5 W/cm², about 330 W/cm², about 332.5 W/cm², about 335 W/cm², about 337.5 W/cm², about 340 W/cm², about 342.5 W/cm², about 345 W/cm², about 347.5 W/cm², about 350 W/cm², about 355 W/cm², about 360 W/cm², about 365 W/cm², about 370 W/cm², about 375 W/cm², about 380 W/cm², about 385 W/cm², about 390 W/cm², about 395 W/cm², about 400 W/cm², about 405 W/cm², about 410 W/cm², 415 W/cm², about 420 W/cm², about 425 W/cm², about 427.5 W/cm², about 430 W/cm², about 432.5 W/cm², about 435 W/cm², about 437.5 W/cm², about 440 W/cm², about 442.5 W/cm², about 445 W/cm², about 447.5 W/cm², about 450 W/cm², about 455 W/cm², about 460 W/cm², about 465 W/cm², about 470 W/cm², about 475 W/cm², about 480 W/cm², about 485 W/cm², about 490 W/cm², about 495 W/cm², about 500 W/cm², about 505 W/cm², about 510 W/cm², 515 W/cm², or about 520 W/cm²,

### EXAMPLES

Examples are provided herein to facilitate a more complete understanding of the invention. The following examples illustrate the exemplary modes of making and practicing the invention. However, the scope of the invention is not limited to specific embodiments disclosed in these Examples, which are for purposes of illustration only, since alternative methods can be utilized to obtain similar results.

### Example 1

### Photoreversible Polymers for Water Dispersibility

This disclosure describes the synthesis and applications of photoreversible cyclobutane-containing polymers that exhibit water dispersibility after photocleavage. For example, cyclobutanes from functionalized coumarin dimers offer opportunities as photoreversible sites in polymer chains. Coumarin is a conjugated compound that can photodimerize at wavelengths around 320 nm and photocleave when exposed to wavelengths<300 nm. This disclosure describes the synthesis of new coumarin dimers possessing diol or diacrylate functionality and subsequent synthesis of new coumarin-containing polymers for photoreversibility. Coumarin diols can be reacted with diisocyanates or dicarboxylic acids/dimethyl esters to form new and photoreversible polyurethane and polyester thermoplastics with tunable properties. Additionally, coumarin diols can be functionalized into diacrylates and then photocured with water soluble/dispersible monoacrylate species, resulting in photocleavable thermosets that exhibit water solubility or dispersibility after photocleavage.

### INTRODUCTION

As the semiconductor industry continues to make new advances in material developments, the synthesis of photoreversible polymers for bond-debond applications is of interest. These materials serve to have strong adhesive properties in the semiconductor manufacturing process, but adhesive strength can effectively be turned off using light at specific reversal wavelengths for debonding steps. Additionally, water dispersibility after photocleavage of the polymer chains is of particular interest in the semiconductor field. This disclosure describes the synthesis of new coumarin-containing polymers for photoreversible polymers that exhibit water solubility or dispersibility after photocleavage.

### Non-Limiting Description

Described herein are photoreversible coumarin-containing polymers that exhibit water dispersibility after photocleavage. Aspects of the disclosure are drawn towards new polymeric system that incorporate photoreversible cyclobutane coumarin dimer groups into the backbone of the polymer. The coumarin dimer groups can be incorporated into a variety of polymeric systems like polyurethanes, polyesters, and polyacrylates that exhibit various properties including high and low glass transition temperatures, elasticity, high impact strength, and optical clarity. The photoreversible yields can be about 20%-100%. For example, about 60%-100%. In embodiments, the response times can vary based on the UVC light intensity. For example, the response time can be less than 1 minute to about 30 minutes depending on UVC light intensity. These polymers can be employed in semiconductor chip manufacturing processes as sacrificial materials during die preparation.

Coumarins are photoactive compounds that photodimerize under UVA irradiation (about 315-350 nm, depending on substituent groups) and photocleave under UVC irradiation (about 285 nm). The incorporation of functional coumarin monomers into polymers enables photoresponsive polymers that lose molecular weight, thus reducing mechanical properties upon UVC irradiation. Polymerizing cyclobutane coumarin dimers with water-soluble or dispersible monomers allows for easy cleaning with water after the photocleavage of the polymer. Described herein are synthetic pathways of substituted photocleavable coumarin monomers for polymerization and the subsequent synthesis of new photocleavable polymers.

The invention described herein employs photo responsive polymer technologies to promote water solubility or dispersity. New chemistries allow for modification of polymer performance and solubilities to nonpolar and polar solvents such as water when exposed to specific wavelengths of light. The solubility of the polymer after UV irradiation depends on the solubilities of comonomers utilized with the coumarin cyclobutanes. For example, comonomers such as poly(propylene glycol), acrylic acid, poly(ethylene glycol), and N-vinyl pyrrolidone will yield water-soluble polymers. This technology can be used in manufacturing processes that involve bond-debonding steps. Water solubility or dispersity of the debonded material is useful in moving away from harsh chemicals to clean material residues.

### SYNTHESIS of Hydroxyethyl Coumarin

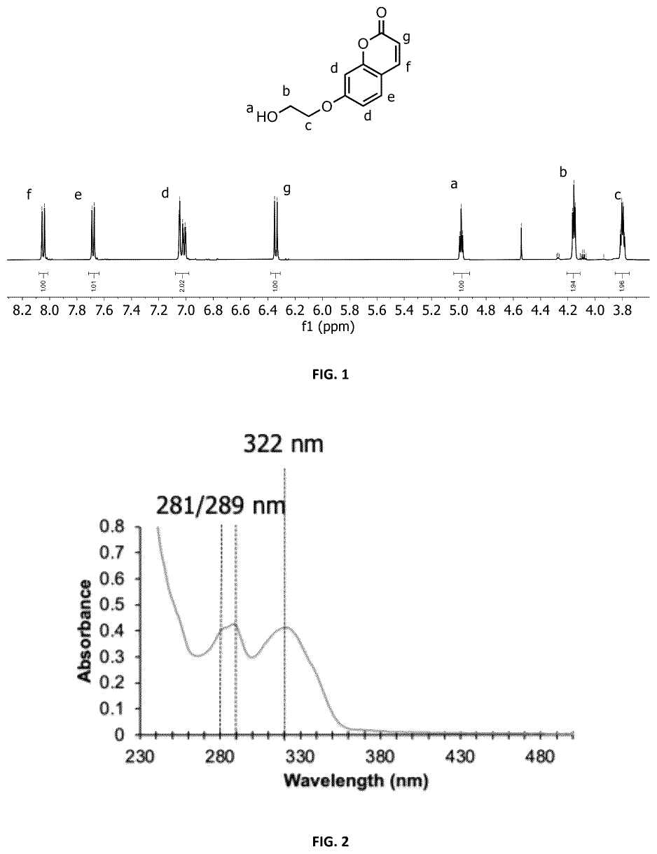

10.0 g (0.0617 mol) of 7-hydroxy coumarin was added along with 11.6 g (0.0926 mol) of bromoethanol, potassium carbonate (33.9 g, 0.246 mol) and acetone (350 mL) were added to a single neck 500 mL round bottomed flask. The reaction was refluxed under an N₂ purge for 48 h. The solids were subsequently filtered off and the solute was concentrated under rotary evaporation. The resulting reaction mixture was purified by column chromatography and characterized by ¹H NMR. TLC: R_{f}=0.67 (ethyl acetate). ¹H NMR (500 MHz, DMSO-d₆) δ 8.05 (d, J=9.5 Hz, 1H), 7.68 (d, J=8.6 Hz, 1H), 7.08-6.98 (m, 2H), 6.34 (d, J=9.5 Hz, 1H), 4.98 (t, J=5.5 Hz, 1H), 4.16 (dd, J=5.9, 3.8 Hz, 2H), 3.80 (q, J=5.1 Hz, 2H). (FIG. 1)

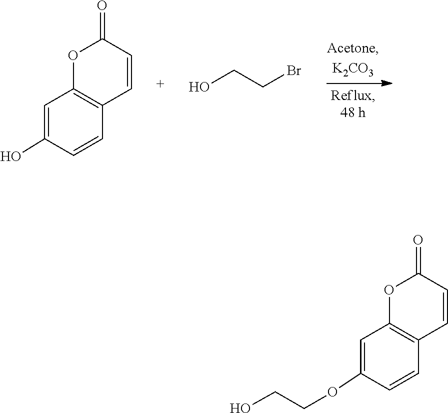

### Scheme 1. Synthesis of Hydroxyethyl Coumarin.

The addition of other alcohol-halogenated compounds can be synthesized via the synthetic strategy outlined in scheme 2.

Notably, the phenolic moiety of the 7-hydroxy coumarin acts as a radical scavenger which hinders dimerization. Therefore, the reactions in Scheme 1 and Scheme 2, functionalizing the phenolic moiety, increase the dimerization yields.

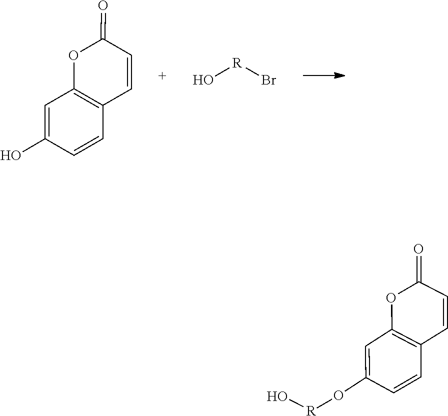

Where R=an alkyl chain with number of carbons ranging from 1-20
   Scheme 2. Synthesis of Hydroxy Coumarin with Varying Carbon Chain Lengths.

### Photodimerization of Hydroxyethyl Coumarin

Coumarin species have high dimerization rates via photodimerization. UV-Vis of the synthesized hydroxyethyl coumarin shows an absorbance peak at 330 nm which indicates the photodimerization wavelength. Upon irradiation with a UV source (filtered to prevent wavelength<300 nm) the hydroxyethyl coumarin will dimerize and yield a cyclobutane dimer possessing diol functionality (Scheme 3). This new photocleavable diol can be used in a variety of polymer syntheses, for example those as described herein.

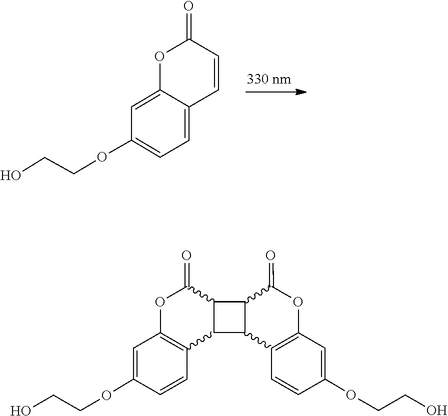 [SMILES: O=c1ccc2ccc(OCCO)cc2o1 ; O=C1Oc2cc(OCCO)ccc2C2C1C1C(=O)Oc3cc(OCCO)ccc3C12]

### Scheme 3. Photodimerization of Hydroxyethyl Coumarin to Make a New Coumarin Diol.

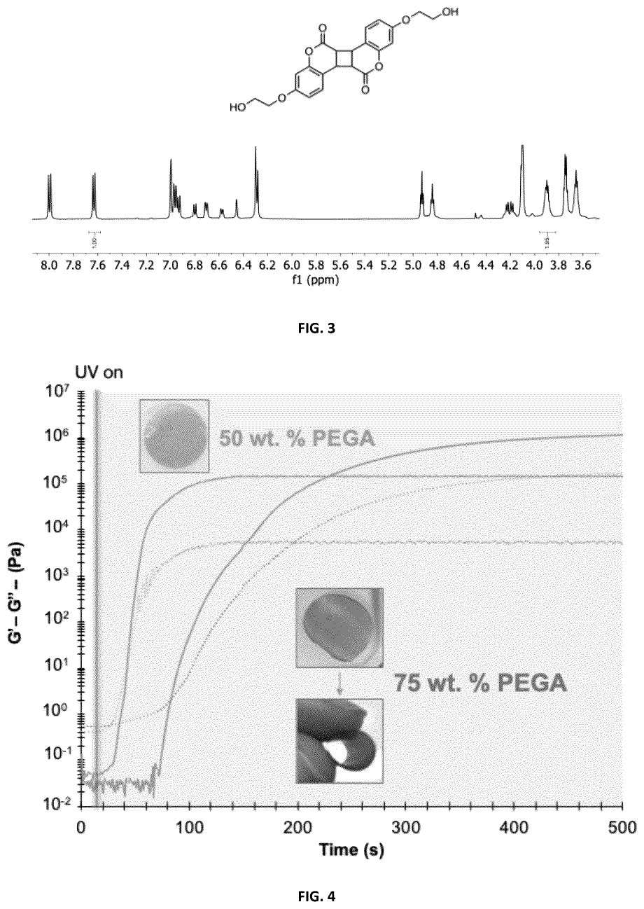

Photodimerization proceeded by irradiating hydroxyethyl coumarin with 1.9 W/cm² of UV light (320-500 nm) for 8 h at 100 °C. The resulting UV vis spectra depicted in FIG. 2 shows the emergence of the hydroxyethyl coumarin dimer at 280-290 nm (whereas the absorbance corresponding to the non-dimerized hydroxyethyl coumarin has a peak absorbance at 322 nm). Additionally, ¹H NMR displayed in FIG. 3 quantitatively displays the dimerization conversion, at 43% dimerization. The resulting mixture of dimers and non-dimers can be further separated and purified so only dimer is isolated. This purification can be achieved through any purification technique known in the art. For example, this purification technique can comprise any chromatography purification technique.

### Synthesis of Coumarin-Containing Thermosetting Polymers

The diol presented in Scheme 3 was further modified to install acrylate functionality for the synthesis of photocurable and photoreversible thermosets as shown in Scheme 4. The dimerization in Scheme 3 produced a mixture of non-dimers and dimers, which were acrylated for photocurable functionality. In a typical reaction, 5 g of the coumarin mixture (containing 43% dimer and 57% non-dimer) were added to a round bottomed flask along with 50 mL of THE and 33 g (0.242 mol) of K₂CO₃. 6.6 g of acryloyl chloride (0.242 mol) was added dropwise and the reaction was stirred for 12 h under nitrogen. The reaction was then filtered, the THF was removed, then redissolved in ethyl acetate. The reaction solution was then washed 3× in an aqueous NaCO₃ solution. The acrylated coumarin mixture was then concentrated under rotary evaporation.

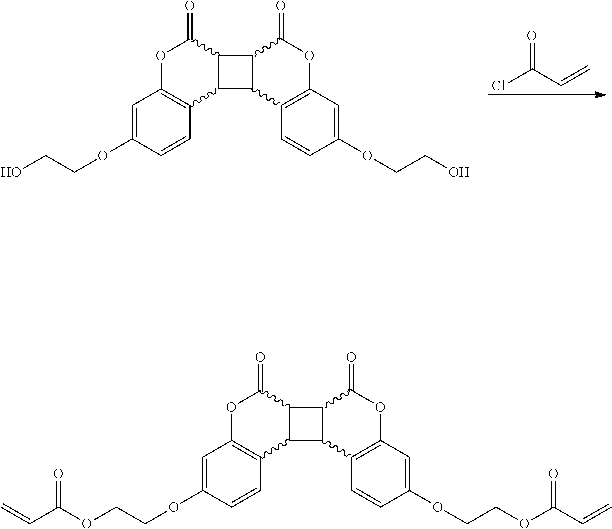

Scheme 4. Acrylation of the Hydroxyethyl Coumarin Diol with Acryloyl Chloride to Form the Diacrylate.

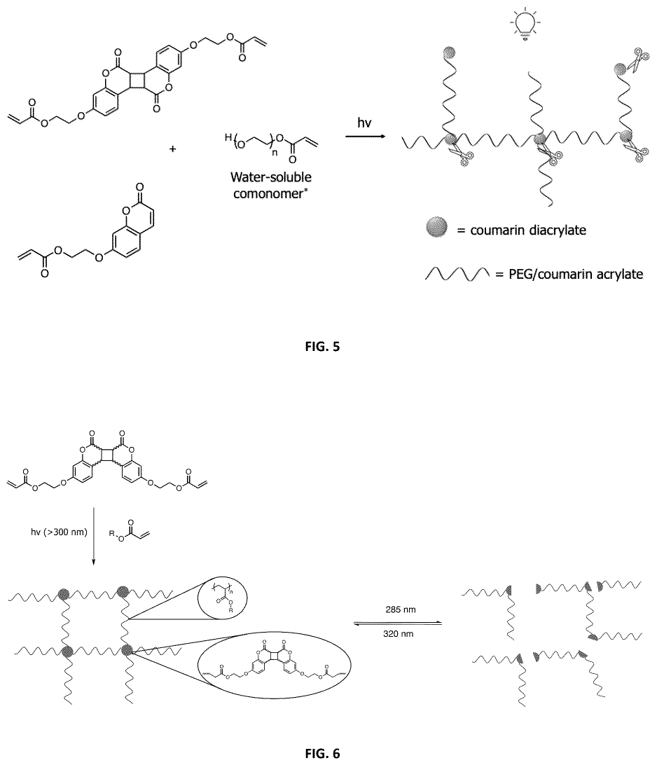

The acrylated coumarin mixture was then mixed with either 75 wt. % or 50 wt. % poly(ethylene glycol) monoacrylate (PEGA, Mₙ=430 g/mol) as a water-soluble comonomer and 1 wt. % phenylbis(2,4,6-trimethylbenzoyl)phosphine oxide (BAPO) as a photoinitiator, as shown in FIG. 5. The photorheology of these two mixtures are displayed in FIG. 4.

The coumarin diacrylate can also be photocured in the presence of a variety of monofunctional acrylates, preferable a water soluble monoacrylate such as acrylic acid, and/or hydroxyethyl acrylate (FIG. 6). These networks will demonstrate photoreversibility at the covalently crosslinked points. Upon UVC irradiation (<300 nm), these crosslinking points will cleave, resulting in water soluble or water dispersible species. In embodiments, a sensitizer can be adding during dimerization. For example, the sensitizer can be any photosensitizer known in the art. For example, the photosensitizer can be any photosensitizer that can facilitate dimerization and reversal reactions. For example, the photosensitizer can be benzophenone.

### Synthesis of Coumarin-Containing Thermoplastic Polymers

The diol functionality of the dimerized coumarin diol allows for the direct synthesis of a variety of new step-growth polymers, including polyurethanes and polyesters. With additional purification and isolation of the coumarin diol (in Scheme 3) the reaction of the hydroxyethyl (or a C₁-C₂₀ hydroxyalkyl) coumarin diol between a diacid will form a photoreversible polyester outlined in Scheme 5, where R represents any alkyl, aryl or other compound exhibiting dicarboxylic acid or dimethyl ester functionality (R′=H or CH₃). For example, a water soluble/dispersible group. The polyester can then be photoreversed into water soluble/dispersible species utilizing a UVC light source that emits wavelengths below 300 nm.

Scheme 6 is a non-limiting, general synthetic strategy for the synthesis of photoreversible coumarin-containing polyurethanes. The hydroxyethyl coumarin dimer can react readily with a diisocyanate, to form a polyurethane. Tuning the R group of the diisocyanate can give photoreversible polyurethanes possessing a variety of thermal and thermomechanical properties. Additionally, utilizing a diisocyanate with an R group representing a water soluble or dispersible substituent can afford a water soluble/dispersible mixture after photocleavage. Photocleavage of the polyurethane chain will proceed under UVC light around 285 nm.

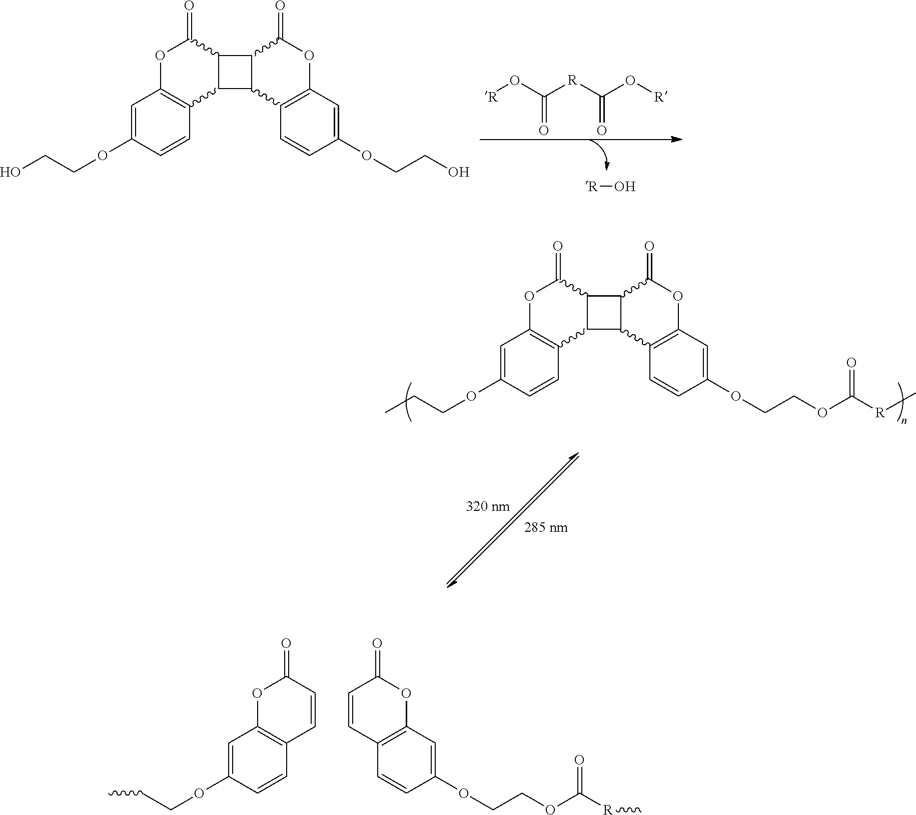

Scheme 5. Synthesis of new photoreversible coumarin-containing polyesters where R=any alkyl, aryl, or other functional group present in dicarboxylic acids and R′=H or CH₃.

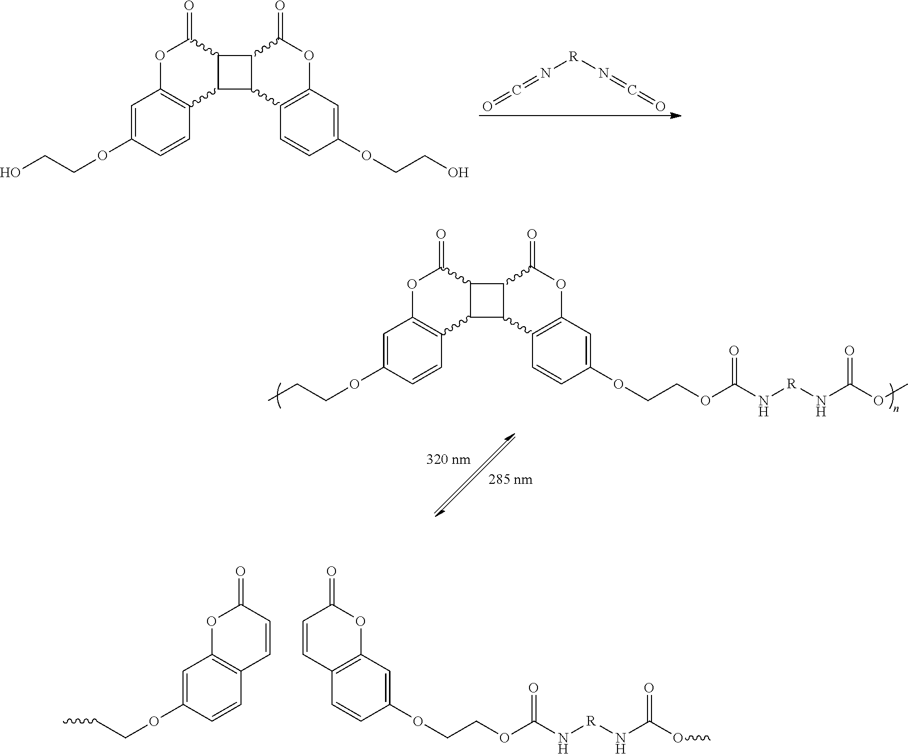

Scheme 6. Synthesis of new photoreversible coumarin-containing polyurethanes where R=any alkyl, aryl, or other functional group found in commercial diisocyanates.

In both the polyurethane and polyester syntheses, small amounts of a trifunctional monomer will also lead to structures with branching, giving unique morphologies and rheological properties.

### Crosslinking of Polyesters and Polyurethanes

In the case of polyesters and polyurethanes an excess of the coumarin diol will yield polymers and oligomers with OH chain-end functionality. These OH groups can be acrylated so that the polymers/oligomers possess diacrylate functionality. Subsequent thermal or photoradical curing of these diacrylates will yield thermosets, where photoreversible groups are present along the main chain rather than at crosslinking points.

### Non-Limiting Advantages Described Herein

Described herein are photoactive coumarins incorporated into the backbone of the polymer. Upon irradiation, the cyclobutane coumarin dimers are cleaved and can easily be washed away with water. A non-limiting, exemplary embodiment of the disclosure is its application in bond-debond adhesives. For example, these compositions can be used as adhesives for bond-debond applications in the semiconductor industry. Additionally, the water cleanability of the coumarin-containing adhesive is an also a new, exciting aspect over current bond-debond adhesives.

While photoreversible cyclobutane-containing polymers have been described in photoresponsive materials, this technology offers distinct advantages for semiconductor manufacturing applications. Unlike other conjugated cyclobutane systems, coumarins demonstrate higher photoreversibility yields (>60%) and faster response times, typically within minutes. Furthermore, the water dispersibility or solubility described in this disclosure addresses a critical need in streamlining the current chip manufacturing process, a feature lacking in existing photoreversible polymers.

### Non-Limiting Commercial Embodiments

In embodiments, this innovation can be employed in the chip manufacturing process as a sacrificial material during die preparation. This preparation involves temporarily adhering a device to a glass substrate for die modification/functionalization. Subsequently, a debonding removes the adhesive release layer from the device wafer and the glass substrate. However, a challenge arises in this step due to the need for costly solvents to clean residual release layer adhesive. By substituting the current release layer with the photoreversible polymers described in this disclosure, the adhesive polymer can be photocleaved into water-soluble/dispersible species. This substitution facilitates a simplified cleaning process, eliminating the need for expensive solvents.

### REFERENCES CITED HEREIN

1. Hughes, T.; Simon, G. P.; Saito, K. Chemistries and Capabilities of Photo-Formable and Photoreversible Crosslinked Polymer Networks. Materials Horizons 2019, 6 (9), 1762-1773.
2. Kaur, G.; Johnston, P.; Saito, K. Photo-Reversible Dimerisation Reactions and Their Applications in Polymeric Systems. Polym. Chem. 2014, 5 (7), 2171-2186.
3. Trenor, S. R.; Shultz, A. R.; Love, B. J.; Long, T. E. Coumarins in Polymers: From Light Harvesting to Photo-Cross-Linkable Tissue Scaffolds. Chem. Rev. 2004, 104 (6), 3059-3077.
4. Cazin, I.; Rossegger, E.; Guedes de la Cruz, G.; Griesser, T.; Schlögl, S. Recent Advances in Functional Polymers Containing Coumarin Chromophores. Polymers 2020, 13 (1). doi.org/10.3390/polym13010056.
5. U.S. Pat. No. 8,258,318
6. U.S. Pat. No. 11,078,368
7. Safavi-Mirmahalleh, S.-A.; Golshan, M.; Gheitarani, B.; Salami Hosseini, M.; Salami-Kalajahi, M. A Review on Applications of Coumarin and Its Derivatives in Preparation of Photo-Responsive Polymers. Eur. Polym. J. 2023, 198, 112430.

### EQUIVALENTS

Those skilled in the art will recognize, or be able to ascertain, using no more than routine experimentation, numerous equivalents to the specific substances and procedures described herein. Such equivalents are considered to be within the scope of this invention and are covered by the following claims.

We claim:

1. A polymer or polymer composition comprising a repeat unit residue of the monomer of Formula (I), 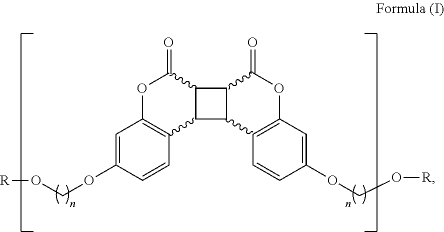
and
at least one comonomer residue, wherein:
n=1-20; and
R=H, a vinyl residue, an acrylate residue, a diacid residue, a diester residue, a diisocyanate residue, a diamine residue, a diamide residue, or a dithiol residue.

2. The polymer or polymer composition of claim 1, wherein:
the vinyl residue is selected from:
an N-vinylpyrrolidone residue, an acrylamide residue, an acrylic acid residue, or 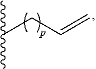
wherein p=0-10;
the epoxy residue is: 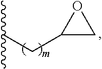
wherein m=1-4;
the acrylate residue is selected from the group consisting of:
a glycol acrylate residue, a hydroxyethyl acrylate residue, or 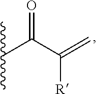
wherein R′=H or C₁-C₃alkyl;
the diacid residue is: 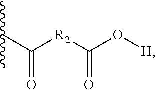
wherein R₂=C₁-C₁₆ alkylene, C₁-C₂₀ alkenyl, C₆-C₈ arylene, naphthylene, oxo, or thioalkylene;
the diester residue is: 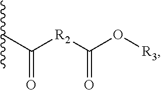
wherein R₂=C₁-C₁₆ alkylene, C₁-C₂₀ alkenyl, C₆-C₈ arylene, naphthylene, oxo, or thioalkylene, and R₃=H or C₁-C₆ alkyl;
the diisocyanate residue is: 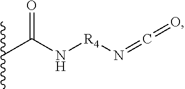
wherein R₄=alkylene, branched alkylene, cycloalkylene, branched cycloalkylene, hetero-cycloalkylene, arylene, naphthylene, alkenyl, oxo, or thioalkylene;
the dithiol residue is: 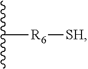
wherein R₆=C₂-C₁₂ alkylene or a substituted C₂-C₁₂ alkylene, wherein the substituents are selected from an ether (—O—) or a carbonyl (—C(═O)—);
the diamine residue is: 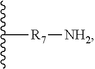
wherein R₇=C₂-C₁₂ alkylene, C₂-C₁₂ branched alkylene, C₆-C₁₄ arylene, biphenylene, hetero-arylene, C₁-C₁₂ hetero-alkylene, or substituted derivatives thereof, wherein the substituents are selected from C₁-C₆ alkyl, C₁-C₆ alkoxy, halo, ether (—O—), carbonyl (—C(═O)—), or sulfone (—SO₂—); and
the diamide residue is: 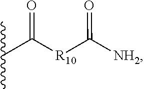
wherein R₁₀=C₂-C₁₂ alkylene, C₂-C₁₂ branched alkylene, C₆-C₁₄ arylene, naphthylene, hetero arylene, C₁-C₁₂ hetero-alkylene, or substituted derivatives thereof, wherein the substituents are selected from C₁-C₆ alkyl, C₁-C₆ alkoxy, halo, ether (—O—), carbonyl (—C(═O)—), or sulfone (—SO₂—).

3. The polymer or polymer composition of claim 1, wherein R=H and the at least one co-monomer residue is selected from the group consisting of:
a diacid monomer residue of: 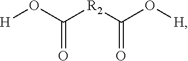
wherein R₂=C₁-C₁₆ alkylene, C₁-C₂₀ alkenylene, C₆-C₈ arylene, naphthylene, —O—, —C(═O)—, or thioalkylene;
a diester monomer residue of: 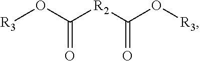
wherein R₂=C₁-C₁₆ alkylene, C₁-C₂₀ alkenylene, C₆-C₈ arylene, naphthylene, —O—, —C(═O)—, or thioalkylene, and R₃=H, C₁-C₆ alkyl, or phenyl;
a diisocyanate monomer residue of: 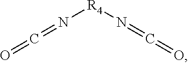
wherein R₄=alkylene, branched alkylene, cycloalkylene, branched cycloalkylene, hetero-cycloalkylene, arylene, naphthylene, alkenylene, —O—, —C(═O)—, or thioalkylene; or
a combination thereof.

4. The polymer or polymer composition of claim 1, wherein R=an epoxy residue and the at least one co-monomer residue is selected from the group consisting of:
a diisocyanate monomer residue of: 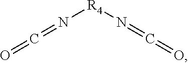
wherein R₄=alkylene, branched alkylene, cycloalkylene, branched cycloalkylene, hetero-cycloalkylene, arylene, naphthylene, alkenylene, —O—, —C(═O)—, or thioalkylene;
a diamine monomer residue of: 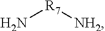
wherein R₇=C₂-C₁₂ alkylene, C₂-C₁₂ branched alkylene, C₆-C₁₄ arylene, naphthylene, hetero arylene, C₁-C₁₂ hetero-alkylene, or substituted derivatives thereof, wherein the substituents are selected from C₁-C₆ alkyl, C₁-C₆ alkoxy, halo, ether (—O—), carbonyl (—C(═O)—), or sulfone (—SO₂—);
a dithiol monomer residue of: 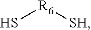
wherein R₆=C₂-C₁₂ alkylene or a substituted C₂-C₁₂ alkylene, wherein the substituents are selected from an ether (—O—) or a carbonyl (—C(═O)—);
a diol monomer residue of: 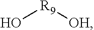
wherein R₉=C₂-C₁₂ alkylene, branched C₃-C₁₂ alkylene, poly(alkylene)oxy alkylene, cycloalkylene, non-phenolic arylene, or ester containing alkylene; or
a combination thereof.

5. The polymer or polymer composition of claim 1, wherein R=a vinyl residue or an acrylate residue and the at least one co-monomer residue is selected from the group consisting of: 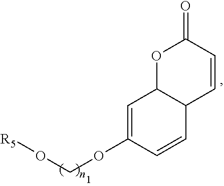
wherein n₁=1-20, and R₅=an acrylate residue, or a vinyl residue;
an acrylate monomer residue;
a vinyl monomer residue;
a dithiol monomer residue of: 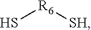
wherein R₆=C₂-C₁₂ alkylene or substituted C₂-C₁₂ alkylene, wherein the substituents are selected from an ether (—O—) or a carbonyl (—C(═O)—);
a diamine residue of: 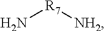
wherein R₇=C₂-C₁₂ alkylene, C₂-C₁₂ branched alkylene, C₆-C₁₄ arylene, naphthylene, hetero arylene, C₁-C₁₂ hetero-alkylene, or substituted derivatives thereof, wherein the substituents are selected from C₁-C₆ alkyl, C₁-C₆ alkoxy, halo, ether (—O—), carbonyl (—C(═O)—), or sulfone (—SO₂—); or
a combination thereof.

6. The polymer or polymer composition of claim 1, wherein R=a diacid residue and the at least one co-monomer residue is selected from the group consisting of:
a diacid monomer residue of: 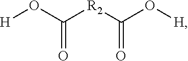
wherein R₂=C₁-C₁₆ alkylene, C₁-C₂₀ alkenyl, C₆-C₈ arylene, naphthylene, —O—, —C(═O)—, or thioalkylene;
a diisocyanate residue of: 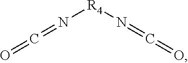
wherein R₄=alkylene, branched alkylene, cycloalkylene, branched cycloalkylene, hetero-cycloalkylene, arylene, naphthylene, alkenylene, —O—, —C(═O)—, or thioalkylene;
a diol monomer residue of: 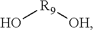
wherein R₉=C₂-C₁₂ alkylene, branched C₃-C₁₂ alkylene, poly(alkylene)oxy alkylene, cycloalkylene, non-phenolic arylalkylene, an ester containing alkylene, or a carbonyl-containing alkylene;
a diamine monomer residue of: 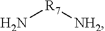
wherein R₇=C₂-C₁₂ alkylene, C₂-C₁₂ branched alkylene, C₆-C₁₄ arylene, naphthylene, hetero arylene, C₁-C₁₂ hetero-alkylene, or substituted derivatives thereof, wherein the substituents are independently selected from C₁-C₆ alkyl, C₁-C₆ alkoxy, halo, ether (—O—), carbonyl (—C(═O)—), or sulfone (—SO₂—);
a dithiol monomer residue of: 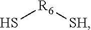
wherein R₆=C₂-C₁₂ alkylene or substituted C₂-C₁₂ alkylene, wherein the substituents are selected from an ether (—O—) or a carbonyl (—C(═O)—); or
a combination thereof.

7. The polymer or polymer composition of claim 1, wherein R=a diester residue and the at least one co-monomer residue is selected from the group consisting of:
a diester monomer residue of: 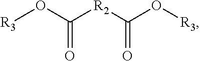
wherein R₂=C₁-C₁₆ alkylene, C₁-C₂₀ alkenyl, C₆-C₈ arylene, naphthylene, —O—, —C(═O)—, or thioalkylene, and R₃=H, C₁-C₆ alkyl, or phenyl;
a diol monomer residue of: 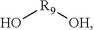
wherein R₉=C₂-C₁₂ alkylene, branched C₃-C₁₂ alkylene, poly(alkylene)oxy alkylene, cycloalkylene, non-phenolic arylalkylene, ester containing alkylene, or a carbonyl-containing alkylene;
a diamine monomer residue of: 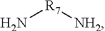
wherein R₇=C₂-C₁₂ alkylene, C₂-C₁₂ branched alkylene, C₆-C₁₄ arylene, naphthylene, hetero arylene, C₁-C₁₂ hetero-alkylene, or substituted derivatives thereof, wherein the substituents are selected from C₁-C₆ alkyl, C₁-C₆ alkoxy, halo, ether (—O—), carbonyl (—C(═O)—), or sulfone (—SO₂—);
a dithiol monomer residue of: 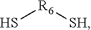
wherein R₆=C₂-C₁₂ alkylene or substituted C₂-C₁₂ alkylene, wherein the substituents are selected from an ether (—O—) or a carbonyl (—C(═O)—); or
a combination thereof.

8. The polymer or polymer composition of claim 1, wherein R=a diisocyanate residue and the at least one co-monomer residue is selected from the group consisting of:
a diacid monomer residue of: 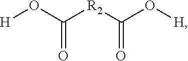
wherein R₂=C₁-C₁₆ alkylene, C₁-C₂₀ alkenyl, C₆-C₈ arylene, naphthylene, —O—, —C(═O)—, or thioalkylene;
a diol monomer residue of: 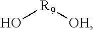
wherein R₉=C₂-C₁₂ alkylene, branched C₃-C₁₂ alkylene, poly(alkylene)oxy alkylene, cycloalkylene, non-phenolic arylalkylene, an ester containing alkylene, or a carbonyl-containing alkylene;
a diamine monomer residue of: 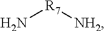
wherein R₇=C₂-C₁₂ alkyl, C₂-C₁₂ branched alkyl, C₆-C₁₄ aryl, biphenyl, heteroaryl, C₁-C₁₂ hetero-alkyl, or substituted derivatives thereof, wherein the substituents are independently selected from C₁-C₆ alkyl, C₁-C₆ alkoxy, halo, ether (—O—), carbonyl (—C(═O)—), or sulfone (—SO₂—);
a dithiol monomer residue of: 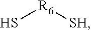
wherein R₆=C₂-C₁₂ alkylene, C₂-C₁₂ branched alkylene, C₆-C₁₄ arylene, naphthylene, hetero arylene, or C₁-C₁₂ hetero alkylene; or
a combination thereof.

9. The polymer or polymer composition of claim 1, wherein R=a diamine residue, the at least one co-monomer residue is selected from the group consisting of:
an acrylate monomer residue;
a diisocyanate residue of: 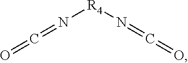
wherein R₄=alkylene, branched alkylene, cycloalkylene, branched cycloalkylene, hetero-cycloalkylene, arylene, naphthylene, alkenylene, —O—, —C(═O)—, or thioalkylene;
a diacid monomer residue of: 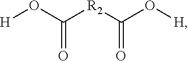
wherein R₂=C₁-C₁₆ alkylene, C₁-C₂₀ alkenyl, C₆-C₈ arylene, naphthylene, —O—, —C(═O)—, or thioalkylene;
a diester monomer residue of: 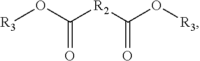
wherein R₂=C₁-C₁₆ alkylene, C₁-C₂₀ alkenyl, C₆-C₈ arylene, naphthylene, —O—, —C(═O)—, or thioalkylene, and R₃=H, C₁-C₆ alkyl, or phenyl; or
a combination thereof.

10. The polymer or polymer composition of claim 1, wherein R=a dithiol residue, the at least one co-monomer residue is selected from the group consisting of:
an acrylate monomer residue;
a vinyl monomer residue;
a diacid monomer residue of: 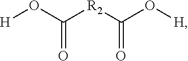
wherein R₂=C₁-C₁₆ alkylene, C₁-C₂₀ alkenyl, C₆-C₈ arylene, naphthylene, —O—, —C(═O)—, or thioalkylene;
a diester monomer residue of: 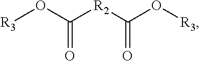
wherein R₂=C₁-C₁₆ alkylene, C₁-C₂₀ alkenyl, C₆-C₈ arylene, naphthylene, —O—, —C(═O)—, or thioalkylene, and R₃=H, C₁-C₆ alkyl, or phenyl; or
a combination thereof.

11. The polymer or polymer composition of claim 1, wherein R=a diamide residue, the at least one co-monomer residue is selected from the group consisting of:
a diamine monomer residue of: 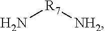
wherein R₇=C₂-C₁₂ alkyl, C₂-C₁₂ branched alkyl, C₆-C₁₄ aryl, biphenyl, heteroaryl, C₁-C₁₂ hetero-alkyl, or substituted derivatives thereof, wherein the substituents are independently selected from C₁-C₆ alkyl, C₁-C₆ alkoxy, halo, ether (—O—), carbonyl (—C(═O)—), or sulfone (—SO₂—);
a diol monomer residue of: 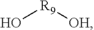
wherein R₉=C₂-C₁₂ alkylene, branched C₃-C₁₂ alkylene, poly(alkylene)oxy alkylene, cycloalkylene, arylalkylene, or ester containing alkylene;
a diisocyanate residue of: 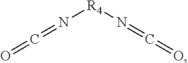
wherein R₄=alkylene, branched alkylene, cycloalkylene, branched cycloalkylene, hetero-cycloalkylene, arylene, naphthylene, alkenylene, —O—, —C(═O)—, or thioalkylene; or
a combination thereof.

12. The polymer or polymer composition of claim 1, wherein the repeat unit residue of the monomer of Formula (I) is present in about 5 mol. % to about 75 mol. % of the at least one co-monomer.

13. The polymer or polymer composition of claim 1, wherein the polymer or polymer composition comprises an Mₙ of about 10,000 g/mol to about 40,000 g/mol.

14. The polymer or polymer composition of claim 1, wherein:
the polymer or polymer composition undergoes photocleavage below about 300 nm;
the polymer or polymer composition undergoes photodimerization at about 315 nm to about 350 nm; and
the polymer or polymer composition is water soluble or water dispersible after photocleavage.

15. The polymer or polymer composition of claim 1, wherein the polymer or polymer composition of is a polyester, a polyurethane, a co-polymer thereof, or a cross-linked polymer or polymer composition thereof.

16. The polymer or polymer composition of claim 1, wherein the polymer or polymer composition is a bond-debond adhesive.

17. A photocleavable adhesive composition comprising the polymer or polymer composition of claim 1.

18. A method of temporarily bonding a support substrate to a semiconductor wafer for processing, the method comprising:
obtaining a device wafer and a support substrate;
applying the photocleavable polymer or photocleavable polymer composition of claim 1 to the surface of the support substrate, thereby forming a photocleavable adhesive layer;
adhering the device wafer to the support substrate by placing it on top of the adhesive layer;
processing the device wafer, thereby curing the photocleavable adhesive layer; and
irradiating the cured photocleavable adhesive layer with a wavelength of less than about 300 nm, thereby debonding the support substrate from the device wafer.

19. The method of claim 18, wherein:
the photocleavable adhesive layer is water soluble or water dispersible after irradiation; and
the photocleavable polymer or photocleavable polymer composition is applied via spincoating.

20. The method of claim 18, wherein:
the adhesive layer is irradiated for about 30 seconds to about 10 min;
the adhesive layer is irradiated at an intensity of about 10 W/cm² to about 500 W/cm²; or
any combination thereof.
